(19) United States
(12) Patent Application Publication
(10) Pub. No.: US 2019/0354915 A1
(43) Pub. Date: Nov. 21, 2019

(54) METROLOGY SYSTEM FOR MEASUREMENT UNCERTAINTY ANALYSIS

(71) Applicant: Minds Mechanical, LLC, Encinitas, CA (US)

(72) Inventor: Jacob Daniel Hockett, Seattle, WA (US)

(21) Appl. No.: 16/347,791

(22) PCT Filed: Nov. 2, 2017
(86) PCT No.: PCT/US17/59772

§ 371 Date: May 6, 2019

(51) Int. Cl. G06Q 10/06; G06F 17/50

(52) U.S. Cl. CPC G06Q 10/06395; G06F 17/50; G06Q 10/06398

(57) ABSTRACT

Certain aspects relate to systems and techniques for acquiring metrology inspection data of manufactured physical parts, identifying measurement uncertainty scores at various stages of the process of manufacturing and inspecting the physical parts, and leveraging the measurement uncertainty scores to evaluate manufacturing setups for the capability to make and/or inspect other parts. The scores can be specific to particular geometric features, and manufacturing setups can be identified for new parts based on the geometric features of those parts. To this end, the metrology system can receive inspection data and tolerance specifications in a variety of formats and convert the data into a standardized feature-based format. Standardized metrology data can be aggregated into appropriate subsets to identify uncertainty attributable to performance of a particular metrology inspector, manufacturing system, or metrology device with respect to specific geometric features of manufactured parts.

### CROSS-REFERENCE TO RELATED APPLICATIONS

The present application claims priority to U.S. Provisional Patent Application No. 62/419,038, filed on Nov. 8, 2016, entitled “METROLOGY SYSTEM FOR MEASUREMENT UNCERTAINTY ANALYSIS,” the contents of which is hereby incorporated by reference herein in its entirety and for all purposes.

### TECHNICAL FIELD

The present disclosure relates to metrology systems, and, more particularly, to systems and methods that enable more efficient manufacturing processes via analysis of metrology inspection information.

### BACKGROUND

Dimensional metrology is used to measure the conformity of a physical part to its intended design. Certain industries, such as aerospace, require manufactured parts to be constructed as very close matches to the computer models or other engineering schematics from which they are generated. There are a number of different 3D measurement devices that can generate data representing measured edges and surfaces of a manufactured physical part, for example laser trackers, portable coordinate measurement machine arms, or coordinate measurement machines. There also exist a number of metrology software options that can compare the measured part data to a computer model to determine how well that particular part matches the model.

### SUMMARY

One aspect relates to a metrology system comprising a computer-readable memory storing executable instructions; and one or more processors in communication with the computer-readable memory, wherein the one or more processors are programmed by the executable instructions to at least identify a plurality of measurements obtained by an inspection operator of a plurality of physical parts; identify a set of the plurality of measurements representing a geometric feature common to a part set of the plurality of physical parts; identify a preliminary measurement uncertainty interval in the set of the plurality of measurements; identify at least one manufacturing system used to manufacture the part set and at least one metrology device used by the inspection operator to inspect the part set; generate an inspector measurement uncertainty interval attributable to the inspection operator at least by subtracting, from the preliminary measurement uncertainty interval, a manufacturing uncertainty interval attributable to the least one manufacturing system and a measurement uncertainty interval attributable to the at least one metrology device; access information representing an additional physical part requiring inspection, the physical part having the geometric feature and the information including a tolerance of the geometric feature; compare the inspector measurement uncertainty interval to the tolerance of the geometric feature of the additional physical part; and based on a result of the comparison, determine whether to recommend the inspector for the inspection of the additional physical part.

Another aspect relates to a metrology system comprising a computer-readable memory storing executable instructions; and one or more processors in communication with the computer-readable memory, wherein the one or more processors are programmed by the executable instructions to at least identify a plurality of measurements of a plurality of physical parts associated with a target machine, the target machine comprising a manufacturing system used to create the plurality of physical parts or a metrology device used to measure the plurality of physical parts; determine, for each measurement of the plurality of measurements, whether an inspector measurement uncertainty interval attributable to the inspection operator who obtained the measurement is known; in response to determining that the inspector measurement uncertainty interval is known, include the measurement in an aggregated measurement set; identify a mean deviation from nominal of the measurements in the aggregated measurement set; identify a mean of the inspector measurement uncertainty intervals of the measurements in the aggregated data set; remove, from the mean deviation, the mean of the inspector measurement uncertainty intervals to generate a machine uncertainty interval attributable to the machine; access information representing a tolerance of an additional physical part requiring manufacture or inspection; compare the machine uncertainty interval to the tolerance of the additional physical part; and based on a result of the comparison, determine whether to recommend the machine for the manufacture or inspection of the additional physical part.

Another aspect relates to computer-implemented method comprising: under control of one or more computing devices configured with specific computer-executable instructions, identifying a plurality of measurements obtained by an inspection operator of a plurality of physical parts; identifying a set of the plurality of measurements representing a geometric feature common to a part set of the plurality of physical parts; identifying a preliminary measurement uncertainty interval in the set of the plurality of measurements; identifying at least one manufacturing system used to manufacture the part set and at least one metrology device used by the inspection operator to inspect the part set; generating an inspector measurement uncertainty interval attributable to the inspection operator at least by subtracting, from the preliminary measurement uncertainty interval, a machine uncertainty interval including a manufacturing uncertainty interval attributable to the least one manufacturing system and a measurement uncertainty interval attributable to the at least one metrology device; and storing the inspector measurement uncertainty interval in association with the inspection operator.

Another aspect relates to a computer-implemented method comprising under control of one or more computing devices configured with specific computer-executable instructions, identifying a plurality of measurements of a plurality of physical parts associated with a target machine, the target machine comprising a manufacturing system used to create the plurality of physical parts or a metrology device used to measure the plurality of physical parts; determining, for each measurement of the plurality of measurements, whether an inspector measurement uncertainty interval attributable to the inspection operator who obtained the measurement is known; in response to determining that the inspector measurement uncertainty interval is known, including the measurement in an aggregated measurement set; identifying a mean deviation from nominal of the measurements in the aggregated measurement set; identifying a mean of the inspector measurement uncertainty intervals of the measurements in the aggregated data set; removing, from the mean deviation, the mean of the inspector measurement uncertainty intervals to generate a machine uncertainty interval attributable to the machine; and storing the machine uncertainty interval in association with the machine.

Another aspect relates to a computer-implemented method comprising under control of one or more computing devices configured with specific computer-executable instructions, (1) calculating a plurality of inspector measurement uncertainty intervals by inputting a plurality of machine uncertainty intervals into the method of the third aspect; (2) recalculating the plurality of machine uncertainty intervals by inputting the calculated plurality of inspector measurement uncertainty intervals into the method of the fourth aspect; (3) recalculating the plurality of inspector measurement uncertainty intervals by inputting the plurality of machine uncertainty intervals back into the method of the third aspect; and (4) iteratively performing steps (2) and (3) for either a predetermined number of iterations or until the plurality of inspector measurement uncertainty intervals and the plurality of machine uncertainty intervals stabilize at a predetermined decimal point.

In some embodiments, step (1) can be performed using default machine uncertainty intervals obtained from calibration data of a plurality of manufacturing systems and a plurality of metrology devices.

Another aspect relates to a metrology system comprising a data repository storing (i) measurements obtained by inspecting physical parts, (ii) supply chain relationship data indicating associations between a manufacturer and its suppliers; and (iii) data relating to uncertainty of the measurements; a computer-readable memory storing executable instructions; and a processor programmed by the executable instructions to detect that engineering schematics of a physical part to be manufactured have been uploaded by the manufacturer; analyze the engineering schematics to ascertain geometric features of the physical part; identify sets of the measurements obtained by particular suppliers of the manufacturer based upon the supply chain relationship data; identify capabilities of the suppliers to manufacture and inspect the geometric features of the physical part based on the uncertainty of the measurements in the sets obtained by the particular suppliers; and output a recommendation of one or more suppliers to be used to build the physical part based upon the identified capabilities.

In some embodiments of the metrology system, the data relating to the uncertainty of the measurements can include inspector uncertainty scores of human inspectors of the suppliers who inspected the physical parts, and the processor can be programmed by the executable instructions to identify the capabilities based at least partly on the inspector uncertainty scores. The processor can be programmed by the executable instructions to calculate an inspector uncertainty score for a particular human inspector by isolating, in a set of the measurements obtained by the human inspector, a portion of the uncertainty attributable to the human inspector. The processor can be further programmed by the executable instructions to calculate a set of inspector uncertainty scores each representing a capability of the human inspector with respect to a different geometric feature represented by the set of the measurements.

In some embodiments of the metrology system, the data relating to the uncertainty of the measurements can include (i) inspector uncertainty scores of human inspectors of the suppliers who inspected the physical parts, (ii) manufacturing uncertainty scores of manufacturing systems of the suppliers that manufactured the physical parts and (iii) metrology uncertainty scores of particular metrology devices of the suppliers used by the human inspectors to inspect the physical parts, and the processor can be programmed by the executable instructions to identify the capabilities based at least partly on the inspector uncertainty scores and based additionally on the manufacturing uncertainty scores and the metrology uncertainty scores. The processor can be programmed by the executable instructions to pre-compute the inspector uncertainty scores, manufacturing uncertainty scores, and metrology uncertainty scores before detecting that the engineering schematics were uploaded from the manufacturer. The processor can be programmed by the executable instructions to identify particular manufacturing systems, particular metrology devices, and particular human inspectors of the subset of the suppliers that have the determined capabilities for manufacturing and inspecting the geometric features of the physical part. The recommendation can identify the particular manufacturing systems, particular metrology devices, and particular human inspectors. The processor can be programmed by the executable instructions to filter, from the subset of the suppliers, any suppliers where the particular manufacturing systems or particular metrology devices are not suitable for manufacturing or inspecting a material of the physical part.

In some embodiments of the metrology system, the data relating to the uncertainty of the measurements can include (i) inspector uncertainty scores of human inspectors of the suppliers who inspected the physical parts, (ii) manufacturing uncertainty scores of manufacturing systems of the suppliers that manufactured the physical parts and (iii) metrology uncertainty scores of particular metrology devices of the suppliers used by the human inspectors to inspect the physical parts, and the processor can be programmed by the executable instructions to identify the capabilities based at least partly on the inspector uncertainty scores and based additionally on the manufacturing uncertainty scores and the metrology uncertainty scores, and to compute the inspector uncertainty scores, manufacturing uncertainty scores, and metrology uncertainty scores as feature-specific scores for particular geometric features based on standardizing the measurements into a feature-based report format. The processor can be programmed by the executable instructions to identify the subset of the suppliers based on, for each geometric feature of the geometric features of the physical part, determining a feature-specific measurement uncertainty score for a particular supplier; and confirming that the feature-specific measurement uncertainty score is below a threshold percentage of a tolerance specified for the geometric feature. The processor can be programmed by the executable instructions to calculate the feature-specific measurement uncertainty score as a combination of the inspector uncertainty score of a particular human inspector, the manufacturing uncertainty score of a particular manufacturing system, and the metrology uncertainty score of a particular metrology device, wherein the inspector uncertainty score, manufacturing uncertainty score, and metrology uncertainty score are feature-specific scores for the geometric feature.

In some embodiments of the metrology system, the processor can be programmed by the executable instructions to aggregate the measurements from inspections of physical parts manufactured based on at least two different engineering schematics; and convert data representing the inspections into a feature-based report format based on clustering particular ones of the measurements by geometric feature. The engineering schematics of the physical part to be manufactured can be different from the at least two different engineering schematics, and the processor can be programmed by the executable instructions to identify that the engineering schematics of the physical part to be manufactured share at least one common geometric feature with the at least two different engineering schematics, and based on identifying the at least one common geometric feature, determine to use the measurements from the inspections to identify the capabilities of the suppliers.

In some embodiments of the metrology system, to output the recommendation the processor can be programmed by the executable instructions to generate measurement uncertainty scores for the subset of the suppliers having determined capabilities for manufacturing and inspecting the physical part, and rank the suppliers based on measurement the measurement uncertainty scores.

In some embodiments of the metrology system, the user receiving the recommendation may be able to click on or otherwise select one (or more) of the recommended suppliers, thereby designating that supplier for building the physical part in the metrology system. This can trigger a request for quote from the supplier, and may cause output of a prompt to the supplier to generate the requested quote for the manufacturer. Thereafter, measurements of a part created by the supplier based on the engineering specifications would be automatically associated with the supplier (and with particular manufacturing systems, metrology devices, and human inspectors used in the part creation lifecycle). This measurement data can later be used to generate updated uncertainty scores for the supplier. A specified manager of the particular manufacturing setup identified in the recommendation may receive a notification requesting that they confirm this designation, and/or a notification scheduling part creation. The user selection may also trigger an automatic scheduling of part creation by a selected manufacturing setup (e.g., where permissions stored in the data repository allow such automatic scheduling). Thus, the user selection of a supplier's manufacturing system in the recommendation may automatically trigger the manufacturing system to produce the desired part.

Another aspect relates to a method comprising, as implemented by one or more computing devices receiving a request from a user to evaluate manufacturing setup capabilities for a physical part to be manufactured based on engineering schematics; analyzing the engineering schematics to ascertain geometric features of the physical part; identifying a manufacturing setup to evaluate for capabilities to manufacture and inspect the physical part; accessing uncertainty scores generated based on analyzing measurement data of other physical parts made by the manufacturing setup, the other physical parts sharing at least one of the geometric features; determining that the manufacturing setup has the capabilities to manufacture and inspect the physical part based on comparing the uncertainty scores to corresponding tolerances of the geometric features; and outputting a recommendation that the manufacturing setup be used to build the physical part based upon the identified capabilities.

In some embodiments of the method, the manufacturing setup includes a manufacturing system, a metrology device, and a human inspector, and the method further comprises accessing the uncertainty scores representing quantities of measurement uncertainty attributable to each of the manufacturing system, the metrology device, and the human inspector for specific geometric features. The method can further comprise, for each geometric feature of the geometric features identifying an uncertainty score of the uncertainty scores that is specific to the geometric feature; identifying a smallest tolerance specified for the geometric feature in the engineering schematics; and determining that the uncertainty score is less than a threshold percentage of the smallest tolerance. This can help ensure that the recommended manufacturing setups are capable of manufacturing the tightest tolerance for a part having a number of the same geometric feature.

Some embodiments of the method further comprise identifying a plurality of manufacturing setups to evaluate with respect to the capabilities to manufacture and inspect the physical part; identifying a subset of the plurality of manufacturing setups that have the capabilities to manufacture and inspect the physical part based on comparing uncertainty scores of particular manufacturing setups to the corresponding tolerances of the geometric features; and including the subset of the plurality of manufacturing setups in the recommendation. The user may be able to click on or otherwise select one (or more) of the recommended manufacturing setups, thereby designating that manufacturing setup for building the physical part. A specified manager of the manufacturing setup may receive a notification requesting that they confirm this designation, and/or a notification scheduling part creation. The user selection may also trigger an automatic scheduling of part creation by the selected manufacturing setup where system permissions allow such automatic scheduling. The method can further comprise identifying the plurality of manufacturing setups based on suppliers associated with a manufacturer. The method can further comprise identifying the plurality of manufacturing setups based on assets associated with a company of the user. In some embodiments, the method can comprise identifying the plurality of manufacturing setups from both assets associated with a company of the user, wherein the company is a manufacturer with designated suppliers, and from suppliers associated with the manufacturer. The method can further comprise filtering, from the subset of the plurality of manufacturing setups, any manufacturing setups not suitable for manufacturing or inspecting a material of the physical part (e.g., manufacturing setups having a manufacturing system or metrology device that is not suitable for the material, where the engineering specifications specify the part material).

Some embodiments of the method further comprise detecting a new upload of the engineering schematics; outputting a prompt to the user, the prompt including an indication that the engineering schematics were uploaded and a user-selectable option to identify manufacturing setups capable of manufacturing and inspecting the part; and analyzing the engineering schematics in response to receiving an indication that the user selected the user-selectable option. The prompt can be output via an appropriate user interface, for example to an account of the user in a browser-based portal, via electronic message, or via an application running on a mobile device of the user.

Another aspect relates to a non-transitory computer-readable medium storing instructions that, when executed, cause one or more computing devices to perform operations for evaluating inspection capabilities for a physical part to be inspected based on engineering schematics, the operations comprising identifying a human inspector to evaluate for capability to inspect the physical part; accessing an uncertainty score representing a quantity of measurement uncertainty attributable to the human inspector; determining that the inspector has the capability to inspect the physical part based on comparing the uncertainty score to a tolerance specified in the engineering schematics for the physical part; and outputting a recommendation that the human inspector be used to inspect the physical part.

Some embodiments of the instructions cause the one or more computing devices to perform operations further comprising analyzing the engineering schematics to ascertain geometric features of the physical part accessing a plurality of uncertainty scores each representing a quantity of measurement uncertainty attributable to the human inspector for a particular geometric feature of the geometric features; and determining that the inspector has the capability to inspect the physical part based on comparing each uncertainty score to the tolerance specified in the engineering schematics for the particular geometric feature. The operations can further comprise generating the plurality of uncertainty scores based on analyzing measurement data of other physical parts that were inspected by the human inspector and share the geometric features of the physical part. The operations can further comprise, for comparing each uncertainty score to the tolerance specified in the engineering schematics for the particular geometric feature, determining that the uncertainty score is less than a threshold percentage of the tolerance. The operations can further comprise identifying the tolerance from a plurality of different tolerances specified for different instances of the geometric feature in the engineering schematics.

Some embodiments of the instructions cause the one or more computing devices to perform operations further comprising identifying a plurality of human inspectors to evaluate with respect to the capability to inspect the physical part; identifying a subset of the plurality of human inspectors that have the capability to inspect the physical part based on comparing uncertainty scores of particular human inspectors to the tolerance; and including the subset of the plurality of human inspectors in the recommendation. The human inspectors may be ranked relative to one another based on their uncertainty scores in some examples. The user may be able to click on or otherwise select one (or more) of the recommended human inspectors, thereby designating that human inspector as the inspector for the physical part. The human inspector may receive a notification requesting that they confirm this designation, requesting a quote for the inspections, and/or a notification scheduling their inspections.

Some embodiments of the instructions cause the one or more computing devices to perform operations further comprising pre-computing the uncertainty score before determining to evaluate the human inspector. Beneficially, where the inspector has inspected a large number of parts and therefore is associated with a large quantity of measurements, pre-computing the score can enable the recommendation to be provided with less latency (e.g., no noticeable delay) than if the uncertainty score was calculated in-line with the recommendation generation. This is particularly true in embodiments which break down the uncertainty score by geometric feature, and embodiments in which a large number of inspectors are evaluated.

Some embodiments of the instructions cause the one or more computing devices to perform operations further comprising generating the recommendation based additionally on a metrology uncertainty score of at least one metrology device identified for use by the human inspector. The operations can further comprise generating the recommendation based additionally on a manufacturing uncertainty score of at least one manufacturing system identified to manufacture the part before inspection by the human inspector. Such recommendations can include a complete manufacturing setup (manufacturing system, metrology device, and human inspector) predicted to be capable of making and inspecting the part within its designated tolerances.

In any of the above aspects, generating the uncertainty scores can involve feature-based analyses as described herein. For human inspectors, with respect to particular geometric features, generating an uncertainty score can include identifying a subset of the measurements representing inspections of the geometric feature by the human inspector; determining a value of an interval of uncertainty in the subset of the measurements, the interval of uncertainty collectively attributable to (i) the human inspector, (ii) one or more of the particular manufacturing systems that manufactured ones of the physical parts subject to the inspections, and (iii) one or more of the particular metrology devices used to perform the inspections; and isolating a portion of the interval of uncertainty that is attributable to the human inspector at least by removing, from the interval, the manufacturing uncertainty intervals of the one or more particular manufacturing systems and the measurement uncertainty intervals of the one or more of the particular metrology devices. The value of the interval of uncertainty in the subset of the measurements can be calculated by calculating mean upper and lower deviation values across the subset of the measurements; and set the value of the interval as the range (e.g., interval) between the mean upper and lower deviation values. Deviation values can be computed based on comparing measured values to nominal values for the particular measurement location from which the measured value was generated. Having knowledge of human-specific measurement uncertainties can be used to refine the uncertainty values of manufacturing systems and metrology devices from their default calibration values, and in turn having knowledge of these refined machine uncertainty values can enable more accurate evaluation of the portion of measurement uncertainty attributable to a human inspector.

These manufacturing process insights and the resulting recommendations can enable more efficient and less wasteful manufacturing processes, among other benefits described in more detail below.

### BRIEF DESCRIPTION OF THE DRAWINGS

The disclosed aspects will hereinafter be described in conjunction with the appended drawings and appendices, provided to illustrate and not to limit the disclosed aspects, wherein like designations denote like elements.

FIG. 1 illustrates a schematic block diagram of an example metrology lifecycle management system and network environment as described herein.

FIG. 2 depicts a flowchart of an example process for generating standardized feature-based inspection reports as described herein.

FIG. 3 illustrates example measurements with associated uncertainty intervals relative to a tolerance range.

FIG. 4 depicts a flowchart of an example process for determining and utilizing manufacturing or inspecting uncertainty.

FIG. 5 depicts a flowchart of an example process for calculating an uncertainty score for an inspection operator.

FIG. 6 depicts a flowchart of an example process for calculating an uncertainty score for a manufacturing system and/or a metrology device.

FIG. 7 depicts an example feedback loop for refining inspector and machine uncertainty scores.

### DETAILED DESCRIPTION

### Introduction

Aspects of the disclosure relate to systems and techniques for leveraging insights gleaned from metrology inspection data to improve manufacturing and inspection processes. For example, the disclosed technology can analyze inspection data to learn the capabilities of the manufacturing systems, metrology inspection devices, and human inspection operators involved in the part creation cycle. The knowledge of these capabilities can be leveraged to create leaner, more efficient manufacturing processes that are less likely to scrap good parts (e.g., due to excessive uncertainty about the inspection values preventing approval of the part inspection) or to approve bad parts (e.g., due to an inaccurate measurement process that causes the bad part to appear in-tolerance).

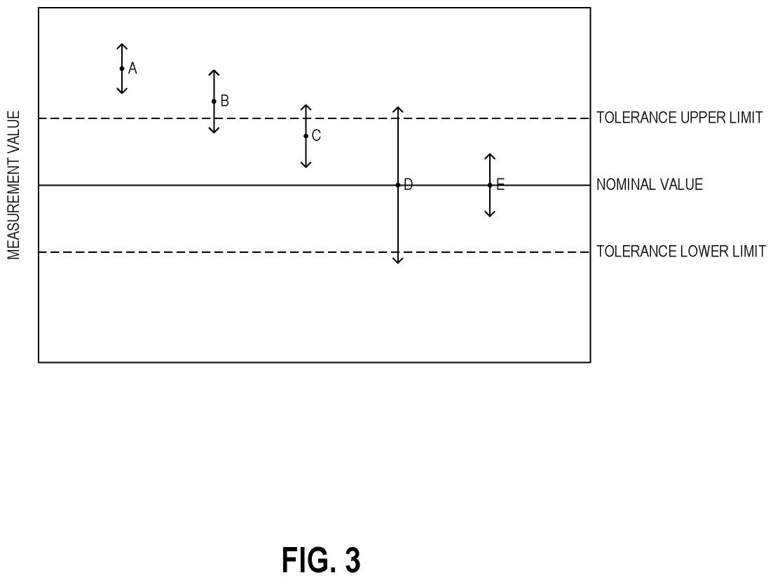

The disclosed technology can acquire metrology inspection data of a number of physical, manufactured parts and standardize the inspection data in a manner that enables the system to isolate a portion of overall measurement uncertainty that is attributable to particular stages of the manufacturing process. Measurement uncertainty is a metric for the amount which the measured shape of an inspected part may reasonably be expected to differ from its actual shape (for further details on measurement uncertainty, see FIG. 3 and associated description). For example, the present technology can identify portions of the inspection data representing specific geometric features of the inspected parts and generate feature-based inspection reports for analysis, rather than relying on the native inspection report format received from a particular metrology device. This technique allows the disclosed inspection data analyses to learn device and inspector capabilities with respect to particular geometric features (e.g., a cylinder, a hole, a flat surface), regardless of whether the same metrology system was used to inspect two different parts in the inspection data or whether those parts have the same shape. The learned inspector and device capabilities can in turn be used to structure manufacturing processes that have small uncertainty compared to the allowable deviations in part shape.

In one embodiment, the system analyzes feature-based inspection reports to identify how precisely a machine can manufacture or measure a certain geometric feature, or how accurately different inspection operators are able to measure certain geometric features. Beneficially, the feature-based analysis enabled by the disclosed inspection data standardization can reveal measurement uncertainties associated with specific metrology inspectors, and such uncertainties can be used to select appropriate inspectors for specific measurement projects or for further training. This can yield more efficient manufacturing processes in some implementations, as the uncertainty attributable to a human inspector of a manual metrology device is typically orders of magnitude larger than the uncertainty due to the device itself.

The described systems can further manage dissemination of the inspections, analyses, and/or other manufacturing and inspection data within a company or supply chain. As described in more detail below, trends in inspection data can reveal problem areas or inefficiencies in manufacturing and inspection processes that may otherwise be undiscovered, and a centralized electronic inspection database can provide for heighted data usability, integrity, and traceability.

### Overview of Certain Benefits

In many industries, a company selling an end product (referred to herein as an “OEM,” which stands for original equipment manufacturer) may request that a portion of a project be manufactured by an outside company (referred to herein as a “supplier”). For example, the OEM company can outsource different portions of the project to a number of different suppliers, and in some cases the same portion can be outsourced to a number of different suppliers. In turn, suppliers may outsource smaller components of their portion of the project to other companies specializing in those components (“sub-suppliers”). As such, the supply chain for the project can extend through many levels of different companies.

Before a part is shipped from a supplier to the requesting company it must undergo a quality inspection, and, especially in industries requiring tight tolerances and/or with mandated inspection processes, each successive recipient is likely to perform their own quality-related measurements of that same part. The measurements of a part can be manually reviewed or compared by metrology software to designated tolerances in order to provide a conformance or non-conformance report. These reports are often provided as print-outs shipped out together with conforming parts, while non-conforming parts cannot be used and thus are typically scrapped at the expense of the supplier.

Existing 3D metrology software is desktop software installed locally on user devices, providing single part analysis to pass or fail one manufactured part at a time based on whether the metrology measurements conform to specified tolerances. Such software can receive, from metrology devices, inspection data representing measurements of a manufactured part and can compare the inspection data to predetermined metrology specifications to determine whether the part has been manufactured within required tolerances. However, the inspection data is typically not utilized beyond determining conformance or non-conformance of the manufactured part, in part due to the differences in the outputs of different metrology devices and software options. For example, a metrology device like a laser scanner can acquire millions of data points representing the surfaces of an inspected part, while a portable coordinate measurement machine arm (“PCMM arm”) can measure a much smaller number of designated points on the surface. These data sets have greatly varying densities and are not easily combinable or comparable in existing systems. Further, each metrology software package has its own way of storing this data in inspection reports, such that there are differences even between two reports from different metrology software package options that represent the same inspections of the same physical. Different metrology software options are optimized for use with different metrology hardware, and both within a single company and throughout a supply chain there are commonly inspections performed using a wide variety of metrology devices and software options.

Conventional statistical process control (SPC) systems require a direct point-to-point match between different inspections in order to identify trends in measurements of that point over time. This, in turn, requires that all parts inspected as part of the SPC process be made from the same engineering schematics (e.g., a CAD model, blueprint, or other engineering design). These points are designated in an inspection instruction file so that each time a part is inspected the same location on the part is measured. Thus, traditional SPC systems require adherence to specific inspection protocols and are limited to analyses of inspections of production runs of the same part, typically implemented with a single measurement device to achieve the precise point-to-point match.

Therefore, a need exists for a quality assessment system that can standardize metrology data from different source formats, aggregate metrology data over time and/or across multiple formats, and provide meaningful analyses of the aggregated data. In addition, there is a need for a quality assessment system that allows a OEM company, among others, to stay informed about the inspection quality and time schedule status of parts in varying stages of the supply chain.

The above-described problems are addressed, in some embodiments, by the electronic metrology lifecycle management systems (“MLM system”) and techniques described herein. The MLM system includes a standardization engine for importing measurement data from a number of different metrology hardware and/or software sources and standardizing the measurement data into a feature-based format for data storage and/or display. As used herein, measurements and measurement data can describe metrology inspection data of points located on a measurand—a physical, manufactured part being inspected. The standardized format can cluster inspection data by geometric features present in the measured part. Geometric features include cylinders, holes, flat or contoured surfaces, spheres, threads, slots, and toroids, to name just a few examples.

As such, inspection data of varying densities and formats acquired from varying metrology hardware and software sources can be aggregated together by feature for analysis. The disclosed feature-based standardization removes the restrictive point-matching limitation from SPC analysis, allowing aggregation and analysis of measurements of the same feature from different parts (for example, two or more parts manufactured based on different models), measurements of the same feature taken by different metrology devices, measurements of the same feature at different locations on the feature, and the like. Thus, analysis based on the disclosed feature-based reports can be used flexibly across a wide range of manufacturing process and provide new insights into process capabilities compared to existing SPC systems.

The feature-based analysis enabled by the disclosed inspection data standardization can reveal measurement uncertainties associated with specific metrology inspectors, manufacturing systems, and/or metrology devices. Measurement uncertainty can represent the precision or accuracy of a device or inspector in creating or measuring a part. For example, a manufacturing uncertainty interval can represent a range of part feature shapes that are likely produced by a given manufacturing system when trying to produce a feature according to a given nominal value. A measurement uncertainty interval can represent, for a given metrology device, a range around a measured value in which the possible actual measurement of the inspected feature can reasonably be expected to fall. Calibration data for manufacturing systems and metrology devices typically includes an approximation of the uncertainty that may be attributed to the device, however this is a static value that does not account for wear and changing conditions over time. The disclosed techniques for feature-based inspection data analysis can be used to adjust these values dynamically as further inspection data is collected over time, such that the machine-specific uncertainty scores of the MLM system stay up-to-date without requiring any additional testing and calibration processes.

An inspector uncertainty interval can represent a range of possible actual measurements of the feature when inspected by a particular human inspection operator. Human inspectors may undergo gage repeatability and reproducibility (“gage r&r”) testing to approximate the amount of uncertainty they introduce into the measurement process. In a typical gage r&r test, a number of different inspectors take turns using the same metrology device to repeatedly measure the exact same part. Because the inspector is the only major variability between measurements, this type of testing can reveal measurement differences between the participating inspectors. This testing involves significant time and resources, and the resulting uncertainty measure has limited applicability as it (1) relates only to the particular test part subjected to the gage r&r, and (2) is a high-level metric of generally how much uncertainty may be attributable to the inspector relative to other inspectors. The disclosed techniques for feature-based inspection data analysis beneficially avoid these limitations, as they operate on inspection data that is already gathered by the inspector during the course of his or her typical employment and thus require no additional testing procedures. Further, the inspection data can involve a diverse set of parts having different shapes and sizes. As such, the resulting uncertainty measures represent inspector capabilities for measuring particular geometric features. These can be used to identify the capability of the inspector with respect to new part shapes (sharing those geometric features) that were not included in the inspection data set from which the uncertainty measures were derived.

With this heightened understanding of the actual uncertainties attributable to different points in the manufacturing and inspection cycle, the MLM system can guide manufacturers to select appropriate equipment/device/inspector combinations for specific parts to improve efficiency and reduce the number of scrapped parts.

Headings are included herein for reference and to aid in locating various sections. These headings are not intended to limit the scope of the concepts described with respect thereto. Such concepts may have applicability throughout the entire specification. Various examples will now be described with reference to the figures for purposes of illustrating and not limiting the disclosed manufacturing quality management systems and techniques.

### Overview of Example MLM System

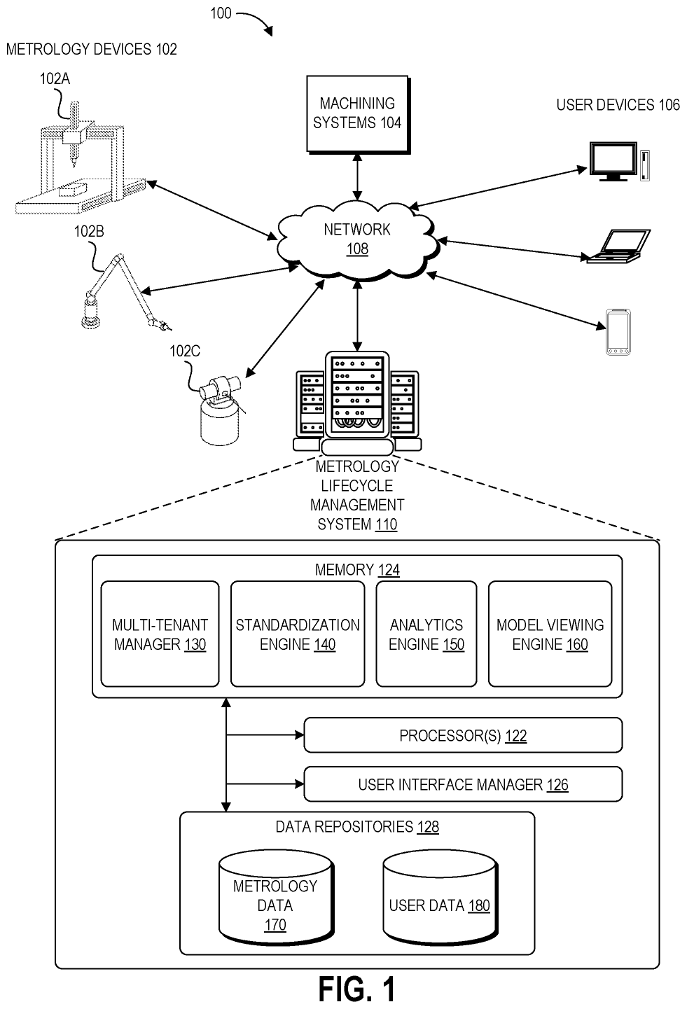

Referring to FIG. 1, an embodiment of a network environment 100 is depicted that can provide users with access to a metrology lifecycle management (“MLM”) system 110 that can provide the described metrology-based manufacturing and inspection management features, among other features. The MLM system 110 can be implemented on a single computer or with one or more physical servers or computing machines, including the example illustrated group of servers. The MLM system 110 includes one or more processor(s) 122, a memory 124 storing modules of computer-readable instructions that configure the processor(s) 122 to perform the functions described herein, a user interface 126, and a data repository 128.

The MLM system 110 can acquire part measurement data in any of a number of different formats, for example from various metrology devices 102A-C including a coordinate measurement machine 102A, PCMM arm 102B, and laser tracker 102C, to name a few. Other examples of metrology devices not illustrated include profilometers, optical comparators, laser scanners, interferometers, LiDAR devices, computed tomography metrology devices, and outer devices capable of obtaining measurements representing surfaces of manufactured parts. The metrology devices 102A-C can cooperate with one or more different metrology software platforms to generate measurement data representing coordinate points along surfaces of physical, manufactured parts. The measurement data can be provided automatically from the metrology devices 102 and/or metrology software to the MLM system 110 via network 108 in some implementations. The MLM system 110 can additionally or alternatively include functionality for users to upload measurement data into the MLM system 110, for example via a browser-based user interface on a user device 106.

The processor 122 may include one or more general purpose computers, dedicated microprocessors, graphics processors, or other processing devices capable of communicating electronic information. Examples of the processor 122 include one or more application-specific integrated circuits (ASICs), graphical processing units (GPUs), field programmable gate arrays (FPGAs), digital signal processors (DSPs) and any other suitable specific or general purpose processors. The processor 122 may be implemented as appropriate in hardware, firmware, or combinations thereof with computer-executable instructions and/or software. Computer-executable instructions and software may include computer-executable or machine-executable instructions written in any suitable programming language to perform the various functions described. The processing of the various components of the MLM system 110 can be distributed across multiple machines, networks, or other computing resources. The various components of the MLM system 110 can also be implemented in one or more virtual machines or hosted computing environment (a.k.a., “cloud”) resources, rather than in dedicated servers.

The data store 128 is a physical electronic data storage that may include one or more data stores, databases, data structures, or the like for storing and/or retaining information associated with the MLM system 110. The data store 128 includes data structures such as metrology data repository 170 and user data repository 180.

The memory 124 can in some embodiments include more than one physical memory, and these can be distributed throughout the MLM system 110. The memory 124 stores program instructions that are loadable and executable on the processor(s) 122 as well as data generated during the execution of these programs. Depending on the configuration and type of memory, the memory 124 can be volatile (such as random access memory (RAM)) and/or non-volatile (such as read-only memory (ROM), flash memory, or other memory). In some examples, the memory 124 includes multiple different types of memory, such as static random access memory (SRAM), dynamic random access memory (DRAM), or ROM.

The memory 124 can store the program instructions as a number of modules that configure processor(s) 122 to perform the various functions described herein, for example the standardization engine 140, multi-tenant manager 130, analytics engine 150, and model viewing engine 160. In some embodiments part or all of one or more of the standardization engine 140, multi-tenant manager 130, analytics engine 150, and model viewing engine 160 can be stored and/or executed elsewhere on a local computer 106 networked with the MLM system 110, alone or in combination with the MLM system 110. The MLM system 110 can access back-end computing devices, which may implement some of the described functionality. Thus, each of the components depicted in the MLM system 110 includes hardware and/or hardware and software for performing various features.

The standardization engine 140 receives measurement data from one or more metrology devices 102 and converts the measurement data to a standardized format. As described herein, the standardization engine 140 can identify geometric features of a part based on its associated GD&T, computer model, or a user-provided template for parts without GD&T or computer models. Inspection data associated with each geometric feature can be stored in association with the geometric feature. Thus, the standardized, feature-based reports of the MLM system 110 are independent of any format specific to a certain metrology hardware or software, and inspection data from a variety of sources can be collected and/or compared by feature.

By standardizing data from different metrology sources, the standardization engine 140 beneficially enables aggregation of data from different sources for analysis. The standardized data can be stored in association with one or more other values, for example in association with an engineering schematic from which a part was created, a manufacturing system used to create the part, an assembly or project including the part, a type of metrology hardware and/or software used to generate the measurement data of the part, an inspection operator user who performed machining and/or metrology inspection of the part, a supplier responsible for manufacturing the part, an OEM requesting manufacture of the part from the supplier, and the like. Such additional parameters can be used to identify specific trends in inspection data and/or to provide alerts to designated users.

The data repository 170 stores such feature-based aggregated standardized measurement data. In some embodiments, the original inspection file can also be stored, for example for provision to a requesting company or OEM. Aggregated data sets in data repository 170 can include, for example, measurements of a number of different parts, measurements of a number of the same part (that is, parts in a run that are manufactured based on the same model or blueprint), or different measurements of the same part at different times and/or by different metrology equipment. As another example, standardized inspection data can be aggregated by feature and associated with a specific manufacturing system used to manufacture the inspected part, metrology device used to perform the inspection, and/or inspection operator performing the inspection.

The data repository 170 includes additional storage storing engineering schematics (including blueprints, CAD models, assemblies, GD&T information, and inspection plans). In this manner, both manufacturing and inspection data are centrally located and can be analyzed together as appropriate. Geometric Dimensioning and Tolerancing (GD&T) is a system for defining and communicating engineering tolerances, and uses a symbolic language on engineering drawings and computer-generated three-dimensional solid models that explicitly describes nominal geometry and its allowable variation. Tolerance limits, as used herein, refer to these allowable variations of a part measurement from nominal. Beneficially, the MLM data repository 170 can be structured to comply with any regulatory requirements within specific industries or supply chains and to provide increased data integrity and traceability.

The analytics engine 150 can provide meaningful statistical analyses of aggregated subsets of the standardized measurement data. Appropriate analysis of aggregated metrology inspection data can provide valuable insights about manufacturing and inspection processes that a single measurement report or part pass/fail indication cannot. For example, the analytics engine can analyze aggregated standardized measurement data of parts manufactured by one or more machines, parts measured by one or more metrology inspectors, parts manufactured by one or more entities in a supply chain relationship, of the same part measured at different points in a supply chain, and the like. Trends identified through analysis of aggregate subsets of measurement data can provide insights into manufacturing and inspection process efficiencies and capabilities, as well as predict potential quality problems. As one example, the feature-based analysis enabled by the disclosed inspection data standardization can reveal measurement uncertainties associated with specific metrology inspectors, and such uncertainties can be used to select appropriate inspectors for specific projects or for further training. The MLM system can implement rule-based reporting for providing results of data analysis to appropriate user(s), and can provide recommendations to improve manufacturing and inspection processes.

In addition or alternatively to standardizing measurement data, the MLM system 110 can compare measurement data of a part to nominal measurements as indicated by an associated GD&T file to identify deviations. In some implementations the metrology system providing the measurement data can additionally or alternatively provide deviation values. The MLM system 110 can compare identified deviations to tolerance values specified at the measurement locations and output conformance or non-conformance reports in any of a number of formats. Such reports or can be automatically provided to users associated within the MLM system 110 with a part or project.

Some implementations of the MLM system (e.g., distributed networked implementations or cloud implementations) can include a multi-tenant management component 130. The multi-tenant manager 130 can manage information flow between users at different levels of a supply chain, for example allowing users to receive quality analyses and manufacturing scheduling updates from users at other levels of the supply chain. This can be accomplished in some examples through automated reporting. Beneficially, the multi-tenant structure can provide important alerts to designated users in real time, for example by providing alerts when inspections reveal non-conforming parts and/or when equipment is nearing or has reached the end of its lifecycle of creating conforming parts. As another example, the system can provide alerts to suppliers as models, blueprints, and/or inspection plans are revisioned by a OEM. Further, the MLM system can provide recommendations of manufacturing systems, metrology devices, and/or inspectors for specific parts based on determined measurement uncertainties as described in more detail below. The multi-tenant structure of the disclosed MLM system can enable aggregate measurements from throughout the supply chain into a single repository.

In one embodiment, the MLM system 110 is a multi-tenant system operated as a network site (such as a web site) or a collection of network sites, which serve network pages (such as web pages) to user devices 106 via the user interface 126. The MLM system 110 can additionally or alternatively host content for one or more mobile applications running on user devices 106. The MLM system 110 can additionally or alternatively host other applications executed by connected metrology devices 102A-102C, machining systems 104, and/or user devices 106. For ease of illustration, this specification often refers to the MLM system 110 in the web site context as being accessed through a browser-based portal. However, this is just one example of how users can be provided with a suitable graphical user interface and the MLM system 110 can be adapted for presentation in desktop applications, mobile applications, or other suitable applications. Such applications can be networked with one another to perform the data transfer functions described herein.

The user interface manager 126 can generate displays and interactive network pages for presenting the information described herein. Though not illustrated, the multi-tenant manager 130 can include a number of supply chain management components that cooperate with the user interface manager 126 to deliver content to networked devices and facilitate user interaction with the delivered content. These components can include an alert management module, an inspection display module, and various modules for managing permissions and/or for inputting the described data types into the MLM system 110, to name a few. An alert management module can provide alerts to designated users, for example, when part inspections are completed, when non-conforming parts are produced, and/or when a model is revisioned. As another example, the multi-tenant manager 130 can an include inspection package reporting engine that can automatically disseminate inspection results and any associated data (photos of inspected parts, original and/or standardized inspection reports, non-conformance reports, and the like) to designated users within a company or supply chain. Companies requesting parts in a supply chain can be provided with the benefits of increased transparency and data delivery times throughout their supply chain. Suppliers of parts in a supply chain can be provided with the benefit of automated provision of quality assessment to their customers, translating to less personnel time spent generating reports and interacting with the customer to provide reports for each supplied part.

The user data repository 180 stores data representing user profiles for companies and/or individuals as well as manufacturing relationships between companies and/or individuals. The user data repository 180 can store specified rules for providing access and alerts to users regarding parts, assemblies, or projects. As such, another aspect of the MLM system 110 relates to its multi-tenant functionality as a supply chain relationship management resource. OEM companies (and others using the software) can specify the particular suppliers that are providing requested parts and also see the suppliers of their suppliers. When an initial part inspection is performed by the manufacturer of a part, the measurement data or a resulting report can automatically be made available in the MLM system 110 to authorized users. In this way, users at varying levels of a supply chain who are involved in the production or supervision of a part can be notified of when the part is inspected, the results of the inspection, and/or when conforming parts are shipped between levels of the supply chain. The user interface manager 126 can provide functionality for users to browse or search for information relating to parts, assemblies, inspections, and the like for which the user has an associated permission to access such data in the user data repository 180.

Certain users in the user data repository can be identified as inspection operators (e.g., human operators of metrology inspection devices). Such inspection operators can have an associated measurement uncertainty, for example as determined via processes 400, 500, and/or 600 described below.

User data repository 180 can also store asset portfolios. An asset portfolio can include the machines of an individual or company using the MLM system 110 that operate within a manufacturing-inspection environment, for example manufacturing systems and/or metrology devices. These machines can each have an associated measurement uncertainty in the asset portfolio.

The metrology data repository 170 and/or user data repository 180 can, in some embodiments, be stored remotely on one or more servers in network communication with the metrology devices 102, machining systems 104, and/or user devices 106. Though shown as two separate data repositories, the metrology data repository 170 and user data repository 180 can be combined into a single data repository or split into a number of different data repositories in various implementations.

In the environment 100, users can access the MLM system 110 with user devices 106. The user devices 106 that access the MLM system 110 can include computing devices, such as desktop computers, laptop computers, tablets, personal digital assistants (PDAs), mobile phones (including smartphones), electronic book readers, media players, game platforms, and electronic communication devices incorporated into vehicles or machinery, among others. The user devices 106 can access the MLM system 110 over a network 108, for example through a browser-based portal.

The network 108 may be any wired network, wireless network, or combination thereof. In addition, the network 108 may be a personal area network, local area network, wide area network, over-the-air broadcast network, cable network, satellite network, cellular telephone network, or combination thereof. For example, the communication network 108 may be a publicly accessible network of linked networks, possibly operated by various distinct parties, such as the Internet. In some embodiments, the communication network 108 may be a private or semi-private network, such as a corporate or university intranet. The communication network 108 may include one or more wireless networks, such as a Global System for Mobile Communications (GSM) network, a Code Division Multiple Access (CDMA) network, a Long Term Evolution (LTE) network, or any other type of wireless network. Protocols and components for communicating via the Internet or any of the other aforementioned types of communication networks are well known to those skilled in the art of electronic communications and thus, need not be described in more detail herein.

The MLM system 110 can rovide users of the user devices 106 with access to an electronic repository of metrology inspection data, 3D CAD models and/or blueprints of parts and assemblies, machining instructions, inspection plans, and/or analysis results provided by the MLM system, to name a few examples. In some implementations, the user interface manager 126 can provide content via a web browsing application such that the functionality of the MLM system 110 can be accessed by a number of different user devices 106. The browser-based user interface can provide functionality for a user to, from any computing device, view and interact with a 2D or 3D representation of the part, to view part measurement data, and/or to view a comparison of deviations between the part measurement data and nominal with predefined tolerance(s). As such, the described MLM system 110 can provide increased access to metrology and manufacturing data compared to existing systems, which typically require specialized software installed locally on a computer in a manufacturing environment. Beneficially, the MLM system extends accessibility of manufacturing and inspection information from the shop floor to anywhere a user may wish to view their process data. Further, the user-friendly, feature-based report format and computer model access available through the model viewing engine 160 enable any person in a company to view and understand models and inspection data, regardless of any specialized training in complicated CAD or metrology software. Another benefit of the MLM system is a reduced need for companies to purchase expensive seats of CAD and metrology software just to be able to view and access their own data.

The model viewing engine 160 of the MLM system can be implemented via a rendering engine of the user interface manager 126 configured for delivering interactive, three-dimensional representations of models and/or measured parts to connected user devices 106. In some examples, a user can view an interactive 3D model of a part with visualization of inspection data overlying the nominal model, even if the graphics processing capabilities of their device are not sufficient to perform three-dimensional graphics rendering. The inspection data overlying the model can include GD&T callouts specifying tolerances, deviations identified from inspections, and/or a heat map showing different colors for inspection measurements based on how well those measurements match the specified tolerances. This can provide an accessible and user-friendly means for presenting models, inspection parameters, and inspection results to users. The rendering engine can provide functionality that enables users to rotate, zoom, or otherwise manipulate the interactive 3D models. The rendering engine can in some embodiments provide users with functionality to specify a manufacturing timeframe, and then can generate an interactive and dynamic heat map that shows the change in the heat map over time for a particular part run.

The MLM system 110 is also configured to receive and/or send information from/to one or more machining systems 104. Machining systems can include mills, lathes, Swiss turn, mold-based manufacturing systems, cutting systems implementing water jets, plasma, or electronic cutting means, 3D printers, routers, and the like. The MLM system 110 can receive, for example, machining plans, machine operation parameters, data from sensors positioned to observe a machining system, and the like. The MLM system 110 can send, for example, machining plans and/or machine operation parameters that have been input or updated by users of the MLM system 110 and/or based on automated analyses of the MLM system 110.

Though described as having multi-tenant capabilities, it will be appreciated that the features of the disclosed MLM system 110 can also be used by a number of users within a single company to manage their internal manufacturing and quality data. Implementations of the MLM system can also be adapted to function without any network capabilities, for example for use in locally managing manufacturing and quality data of restricted projects. Restricted projects can include projects requiring a certain level of governmental clearance or any other project that a company may desire to keep private. As such, in some examples no information may flow out of the MLM system 110 to other sources and all information can be used locally. In such embodiments the processor(s) 122, data repositories 128, standardization engine 140, analytics engine 150, and model viewing engine 160 can be stored and/or executed by a local computing device hosting the non-networked implementation of the MLM system 110.

### Overview of Example Inspection Standardization

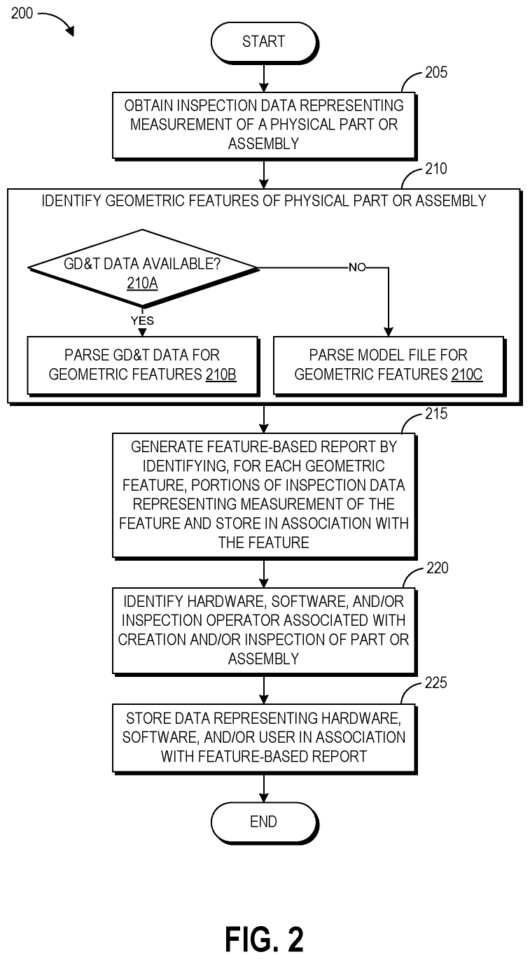

The MLM system 110 can open inspection data files across a range of available formats and to standardize the inspection data. FIG. 2 illustrates an example process 200 for standardizing inspection data and can be implemented by the standardization engine 140 in some embodiments. The process 200 can standardize different formats and/or densities of metrology inspection data based on geometric features for aggregation and analysis and/or display in a unified format.

At block 205, the standardization engine 140 can obtain inspection data representing measurement of a physical part. For example, in some embodiments the MLM system 110 can provide a user interface for users to upload inspection reports. In some embodiments, the MLM system 110 can be in direct communication with a metrology device and/or computing device hosting metrology software such that inspection data is automatically imported into the MLM system as it is acquired. Though the process 200 will be described in the context of part inspection, the process 200 can also be applied to assembly inspections. A part refers to a single, unitary part while an assembly refers to the coupling of two or more parts.

At block 210, the standardization engine 140 can identify geometric features of the part represented by the inspection. In some embodiments, inspection data obtained by the standardization engine 140 can be associated with a specific part in the data repository 170. Preferably, the part will also be associated with a GD&T file specifying nominal measurements and tolerances at a number of locations on the part. As indicated by block 210A, the standardization engine 140 can, in some embodiments, first check whether a GD&T file is associated with the inspected part. If so, at block 210B the standardization engine 140 can parse through the GD&T file to identify reference to any geometric features of the part. Some parts may not have an associated GD&T file. In such cases, as shown by block 210C, the standardization engine 140 can parse through the data representing the model to identify reference to geometric features, for example in the element IDs of a three-dimensional CAD file. Blocks 210A-210C represent some of the options available to the analytics engine 140 for identifying part features. In some implementations no GD&T or model may be available in the MLM system for the inspected part, and the standardization engine 140 can parse through headers of the inspection data file to identify reference to any geometric features. The described parsing can be implemented in some embodiments via fuzzy logic. Some parts may be created based off of two-dimensional blueprints, and for such parts a user may upload a mapping of the geometric features of the part usable by the standardization engine 140 to identify the geometric features. In some embodiments, the standardization engine 140 can output a listing of the geometric features of the part for storage in association with the part in the data repository 170 such that the listing is generated once for an initial inspection of the part and then accessed for subsequent inspections of the part.

At block 215, the standardization engine 140 can generate a feature-based report by identifying, for each geometric feature, portions of the inspection data representing measurement of the feature. For example, the standardization engine 140 can parse through headers of the inspection file, map the headers to the identified geometric features, and store all data points under the inspection file headers with the associated identified feature. The data points from the inspection file can include a measurement value and x,y,z coordinates of the data point.

As an example, a first feature-based report can include six data points representing a cylinder measured by a PCMM arm, and a second feature-based report can include thousands of points representing the cylinder measured by a laser tracker. However, both reports are formatted to specify that the data points represent a cylinder. Thus, the feature-based report formatting provides the ability to aggregate inspection data from different formats based on features and/or to present a single way of viewing inspection data from any source.

At block 220, the standardization engine 140 can identify any hardware, software, and/or inspection operator associated with creation and/or inspection of part or assembly. Hardware can include a manufacturing system used to make the part and/or a metrology device used to inspect the part. Software can include a program used to run the manufacturing system, a program used to run the metrology device, or a metrology software option used together with the metrology device. In some embodiments, a user uploading an inspection file can specify this information, and/or the data repositories 170, 180 of the MLM system 110 may include this information. In some embodiments the standardization engine 140 can implement fuzzy logic to search inside of headers in the inspection file for metrology hardware and/or software information.

At block 225, the identified information regarding hardware, software, and/or inspection operator is stored in association with the feature-based report, for example in data repository 170.

Standardizing inspection data as illustrated in FIG. 2 can provide several advantages. For example, prior manufacturing statistical process control (SPC) systems are limited to analyzing direct point-to-point matches on inspected parts and thus require development of and adherence to specific inspection plans that outline the points needed for SPC analysis. In addition to requiring detailed inspection plans, existing SPC systems are limited to analyzing data from the same type of measurement hardware and software due to relying on the point-to-point comparison. In contrast to these existing systems, the disclosed MLM system can aggregate part measurements by feature from any measurement device and without inspection plans.

One benefit of the standardized data is that the MLM system 110 is capable of analysis and comparison of inspection data from different sources. For instance, before a part is initially shipped from its original manufacturer it typically must be measured for quality assessment to ensure that it meets the required level of accuracy. This same part is often measured by the recipient to double check the accuracy before using the part. Using the standardization engine 140 and analytics engine 150, these two measurements (and any further measurements of the part as it continues to travel down the supply chain) can be automatically standardized and aggregated, despite being taken in different locations, and different times, and possibly using different measurement hardware and/or software.

Over time, trends in this data can reveal where in a supply chain inaccurate measurements are occurring, enabling downstream customers to make more informed decisions for regulating their sources and to save money by reducing the number of parts scrapped for inaccuracy. Further, part recipients can use aggregate quality data (or rankings generated therefrom) to make judgments of their suppliers regarding how close to tolerance their parts are generally, and how well-controlled their manufacturing process is. Currently the part recipient would have to manually compare the individual data sets provided as a printed report with each part to make this kind of judgment, so the MLM system both saves the part recipient time as well as provides them with a depth of analysis not possible from visually comparing printed reports. In one aspect, aggregated inspection data can be analyzed to rank specific individuals or companies in a supply chain or industry based on metrics such as measurement data accuracy, delivery time, and/or part conformance to tolerances. Such rankings may be used to provide specific supplier recommendations to OEM companies (or to other tiers of a supply chain) based on performance track record. Knowledge gained through such rankings can enable companies to increase efficiency in their supply chain relationships.

Another advantage of the standardization process of FIG. 2 relates to presentation of inspection reports to users. Existing metrology software is both expensive and involves a steep learning curve, which often limits the number of employees at a given company who are able to view and understand inspection reports. In contrast, the MLM system can open files across a range of available formats and standardize the inspection data as described with respect to FIG. 2. These standardized inspection reports can be displayed to users, for example in a browser-based interface accessible via any connected and authorized device. The inspection reports can also be mapped to the geometric features of models used to generate the inspected parts and overlaid onto the models, for example as a heat map showing where in-tolerance and out-of-tolerance measurements occurred. Regardless of what metrology hardware and/or software was used to generate a metrology inspection and/or surface analysis of a physical part, a user can open that file using the MLM interface to view the quality analysis in a single report format or overlaid onto the associated model, eliminating the need for users to familiarize themselves with the reporting formats of a number of different metrology software. Such display techniques can increase the availability and understandability of inspection data.

### Overview of Measurement Uncertainty

In metrology, measurement uncertainty is the quantitative evaluation of the reasonable values that are associated with a measurement result. It is generally accepted that no measurement is exact. When a manufactured part is measured during inspection, the measurement value depends on factors including the measuring system, the measurement procedure, the skill of the operator, the environment, and other effects. Even if the object were to be measured several times, by the same operator and in the same way and in the same circumstances, a different measured value would in general be obtained each time, assuming that the measuring system has sufficient resolution to distinguish between the values. Thus, a measured value may not correspond to the actual value of the measured part, and measurement uncertainty is a probabilistic expression of this margin of doubt in a particular measurement value.

Measurement uncertainty can include two values, an interval and a confidence level. The interval characterizes the range or probabilistic distribution representing the possible actual value of the measurand based on the measurement value, where measurand as used herein refers to a physical, manufactured part or assembly of parts that is being measured. The interval is sometimes expressed as the measured value plus or minus a value, though the positive and negative distances from the measured value defining the interval do not have to be the same. The confidence level characterizes the level of certainty that the actual value of the measurand is within the interval. As such, measurement uncertainty is an indicator of the quality and reliability of measurement results. All measurements are subject to uncertainty and a measurement result is complete only when accompanied the associated uncertainty.

With respect to determining whether a measurand falls within tolerance, the uncertainty must be known before it can be determined whether tolerance is met. Turning to FIG. 3, dots representing measurement values of five example measurements A, B, C, D, E are shown relative to nominal (ideal or desired) and upper/lower tolerance limit values for a measurand. The vertical arrows extending from the values represent the associated uncertainty intervals. For purposes of simplicity with the example of FIG. 3 the upper and lower tolerance limits are depicted as being equal distances from nominal and the upper and lower portions of the uncertainty intervals are depicted as being equal distances from the measurement value. However, in practice the upper and lower tolerance limits and/or portions of uncertainty intervals can differ from one another.

Based on the measurement value and uncertainty interval, nonconformity of measurement A with the designated tolerances can be proven. Because the uncertainty intervals for measurements B, C, and D overlap with values both within the tolerance limits and outside of these limits, conformity or nonconformity of measurements B, C, and D cannot be proven, even though measurement B is outside of the upper tolerance limit, measurement C is between nominal and the upper tolerance limit, and measurement D is equal to nominal. Based on the measurement value and uncertainty interval, conformity of measurement E with the designated tolerances can be proven.

As shown in FIG. 3, measurements D and E have the same measurement value but the uncertainty interval of measurement D is larger than the uncertainty interval of measurement E. As illustrated by measurements D and E, it is more likely that the measurand will be determined to be out of tolerance as the uncertainty interval increases, even if the (unknown) actual measurand value is within tolerance.

Existing metrology practices typically base uncertainty intervals on two factors: (1) the uncertainty interval of the manufacturing system use to make a part and (2) the uncertainty interval of the metrology device used to measure the part. Such intervals are typically based on calibration specifications provided by the equipment or device manufacturers. However, human inspection operators add an additional layer of uncertainty that cannot be accounted for by the equipment or device uncertainty. Due to the limitations of conventional inspection report formatting, existing systems do not calculate inspector-specific uncertainty. Consider the example that measurements A-E were each taken by one of inspectors A-E, and that the uncertainty intervals are part of inspector uncertainty scores (as discussed in more detail below) representing the amount of uncertainty in a measurement that is attributable to the inspector. Because the uncertainty interval of inspector D exceeds the interval between the lower and upper tolerance limits, no measurement performed by inspector D for this particular measurand can conclusively be proven as in-tolerance.

Additionally, the calibration data for manufacturing systems and metrology devices may or may not be accurate, and may change over time. Consider a different example where measurements D and E are each taken by metrology device F. If the smaller uncertainty interval E represents the uncertainty interval of the device provided by the calibration data but the larger uncertainty interval D represents the actual uncertainty of the device in operation, measurement E may be erroneously proven in-tolerance based on interval E while the actual measurement lies along interval D above the upper tolerance limit or below the lower tolerance limit. This can result in shipment and/or assembly of a “conforming” part that is, in reality, nonconforming. Conversely, if the larger uncertainty interval D represents the uncertainty interval of the device provided by the calibration data but the smaller uncertainty interval E represents the actual uncertainty of the device in operation, the device may be excluded from measuring parts that it is actually capable of measuring within tolerance.

In manufacturing, reworking or scrapping out of tolerance parts can be costly, particularly in industries such as aerospace where a single titanium part can cost thousands of dollars to manufacture. Further, parts are inspected both before shipping to a customer and upon receipt by the customer. If a supplier provides a part to a customer with a conformance report, but the receiving inspection produces a non-conformance report, it either (A) gets shipped back to the supplier or (2) repeated measurements must be taken to identify whether part is actually conforming and whether the error occurs at the level of the supplier or the customer. This generates inefficiency and potential strain on relationships within the supply chain.

As such, there is a need for tools to more accurately identify and utilize measurement uncertainty to improve measurement processes.

### Overview of Example Uncertainty Analysis

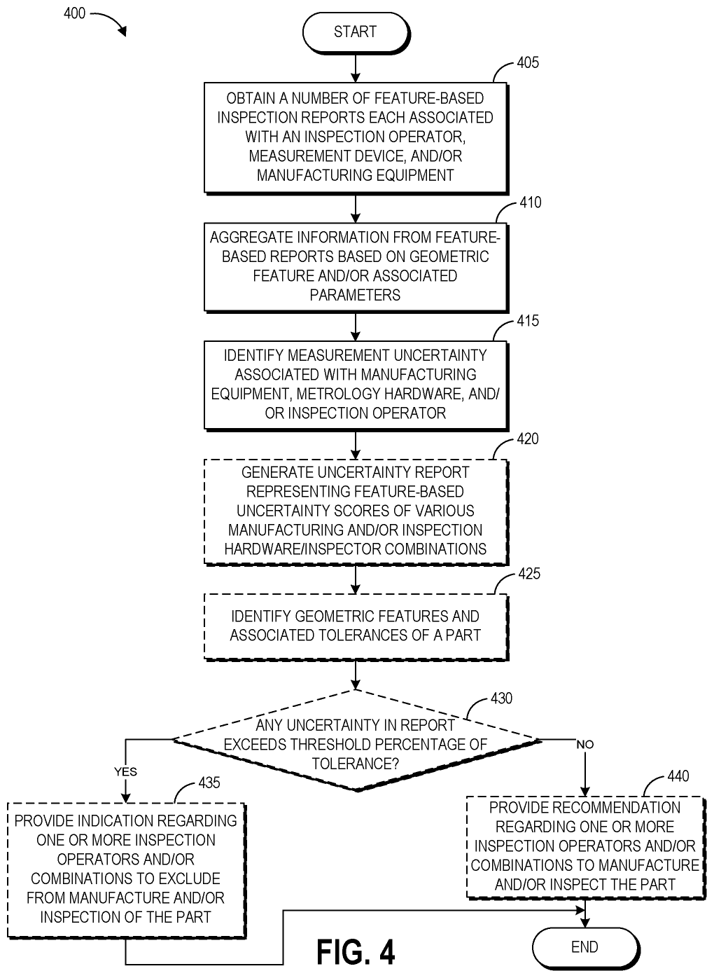

The MLM system 110 can analyze feature-based inspection reports to determine an overall interval of measurement uncertainty in a particular set of measurements. This interval is reflects a collective uncertainty that is attributable to a manufacturing system used to manufacture the inspected part, a metrology device used to inspect the part, and the inspection operator who carried out the inspection. The MLM system 110 can then isolate a particular portion of that interval attributable to the human inspection operator, for example by removing the uncertainties attributable to the manufacturing system used to manufacture the inspected part and the metrology device used to inspect the part. These device-related uncertainty scores may initially be based on calibration data provided by manufacturers or testers of the devices, however the MLM system 110 can update these values to reflect device wear after learning the uncertainties attributable to particular human inspectors involved in the process. FIG. 4 illustrates an example process 400 for determining and utilizing uncertainty calculations to improve manufacturing process efficiency, and can be implemented by the analytics engine 150 in some embodiments.

At block 405, the analytics engine 150 can obtain or generate a number of feature-based inspection reports each associated with an inspection operator, measurement device, and/or manufacturing system. In preferred embodiments, feature-based inspection reports are associated with each of a manufacturing system used to manufacture the inspected part, a metrology device used to inspect the part, and the inspection operator who carried out the inspection. However, in some embodiments a feature-based inspection report may be associated with only one or two of these pieces of information. In some embodiments, the process 400 may use inspections of a number of geometric features conducted within a particular tolerance range (e.g., 1/1000^{th} of an inch) to determine uncertainty within a particular tolerance range rather than for a particular geometric feature.

At block 410, the analytics engine 150 can aggregate information from feature-based reports based on geometric feature and/or associated parameters, as discussed in more detail with respect to the examples of Table 1. The data can be aggregated appropriately for identifying a target measurement uncertainty associated with one or more of the manufacturing system, metrology device, inspector, and feature size range. It will be appreciated that inspection data sets can be generated using different units of measurement, for example inches and millimeters, and aggregated data sets are standardized so that all measurements are converted to the same unit of measurement.

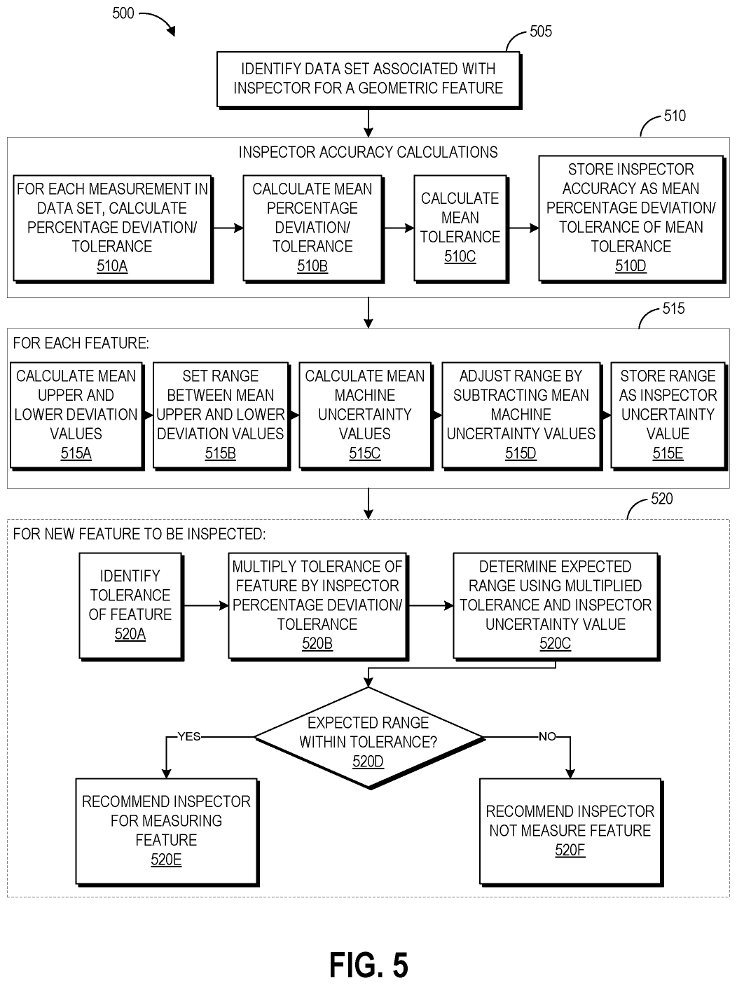

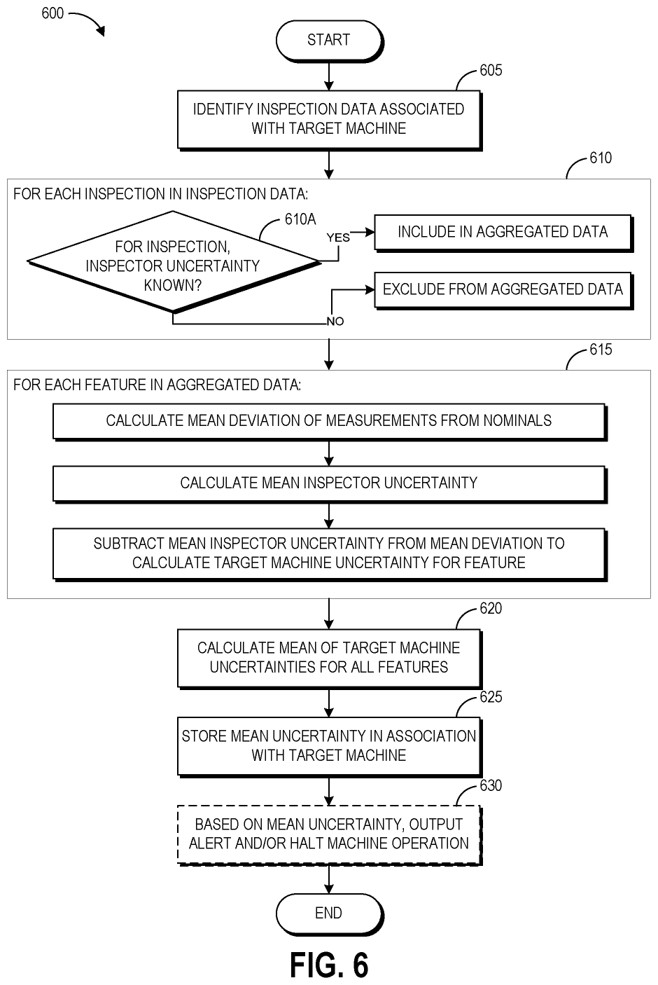

At block 415, the analytics engine 150 can identify or calculate measurement uncertainty associated with the manufacturing system, metrology hardware, and/or inspection operator, across all feature sizes or at a determined size range. An example of a process for calculating the uncertainty associated with an inspector is discussed in more detail with respect to FIG. 5, and an example process for calculating the uncertainty associated with a manufacturing system and/or a metrology device is discussed in more detail with respect to FIG. 6. In some implementations machine uncertainty can be obtained from default calibration data provided from the machine manufacturer. The uncertainty can be represented, in some embodiments, as an interval representing a range of measurements above and/or below the actual measurement value, where the (unknowable) real measurement of the part is likely to fall within the range.

Example aggregated data sets and example meanings or significances of the resulting calculated measurement uncertainties are illustrated in Table 1, below. These examples are meant to provide an overview of how different sets of data can be aggregated so that analysis will provide specific insights into manufacturing and inspection process accuracies and capabilities, and it will be appreciated that other data sets can be aggregated an analyzed as desired.

TABLE 1

| Example | Aggregate Data Set(s) | Analysis Result |
|---|---|---|
| 1 | All sphere measurements performed by | Global uncertainty score for |
| | inspector A across all manufacturing systems | inspector A with respect to |
| | and all metrology devices | measuring spherical geometric |
| | | features |
| 2 | All cylinder measurements performed by | Uncertainty score for inspector |
| | inspector A across all manufacturing systems | A with respect to cylindrical |
| | using all PCMM arms | geometric features measured |
| | | with PCMM arms |
| 3 | All hole measurements performed by inspector | Uncertainty score for inspector |
| | A on parts manufactured by CNC A using laser | A with respect to hole features |
| | tracker A | manufactured by CNC A and |
| | | inspected using laser tracker A |
| 4 | (1) All cylinder measurements performed by | The difference between the |
| | inspector A across all manufacturing systems | uncertainty scores resulting |
| | and all metrology devices | from analysis of data sets (1) |
| | (2) All cylinder measurements performed by | and (2) can provide insight into |
| | inspector B across all manufacturing systems | the relative performances of |
| | and all metrology devices | inspector A and inspector B |
| | | when inspecting cylinders |
| 5 | (1) All cylinder measurements performed by | The difference between the |
| | inspector A on parts manufactured by CNC A | uncertainty scores resulting |
| | using laser tracker A | from analysis of data sets (1) |
| | (2) All cylinder measurements performed by | and (2) can indicate uncertainty |
| | inspector A on parts manufactured by CNC B | that is actually attributable to |
| | using laser tracker A | CNC A and CNC B when |
| | | manufacturing cylinders |
| 6 | (1) All cylinder measurements performed by | The difference between the |
| | inspector A on parts manufactured by mold A | uncertainty scores resulting |
| | using laser tracker A | from analysis of data sets (1) |
| | (2) All cylinder measurements performed by | and (2) can indicate uncertainty |
| | inspector A on parts manufactured by mold A | that is actually attributable to |
| | using laser tracker B | laser tracker A and laser |
| | | tracker B when measuring |
| | | cylinders |
| 7 | (1) All cylinder measurements performed by | The difference between the |
| | inspector A on parts manufactured by mold A | uncertainty scores resulting |
| | using laser tracker A, where the nominal value | from analysis of data sets (1) |
| | of the cylinder diameter is 0.5 mm and below | and (2) can indicate specific |
| | (2) All cylinder measurements performed by | uncertainty scores of inspector |
| | inspector A on parts manufactured by mold A | A when measuring small (data |
| | using laser tracker A, where the nominal value | set (1)) or large (data set (2)) |
| | of the cylinder diameter is above 0.5 mm | cylinders |

Referring specifically to example 3, the process 400 can generate uncertainty scores for specific equipment/metrology device/inspector combinations in order to provide recommendations to manufacturers for meeting specific tolerances on specific geometric features, beneficially enabling reduction of parts scrapped due to usage of manufacturing systems, metrology devices, or inspectors that cannot with certainty manufacture or measure that feature at the specified tolerance.

As shown via examples 4-6, the process 400 can generate two or more data sets in which one of the three associated process variables (manufacturing system, metrology device, and inspector) is varied in order to isolate the particular quantity of measurement uncertainty that is attributable to the varied process variable. As shown via example 7, the three process variables can be kept the same but multiple data sets can be generated based on the nominal size of the measured feature in order to identify inspector (or, in other examples, manufacturing systems and/or metrology device) uncertainty at different size ranges. Although such analyses can be performed using two data sets as shown in Table 1, use of more data sets can provide more accurate or refined uncertainty calculations.

Turning now to optional blocks 420-440, an example application of the described uncertainty score will be described. In alternative processes, the MLM system can use the results of blocks 405-415 of the process 400 for other purposes, for example to recommend training for specific inspectors, to exclude specific inspectors from performing certain measurements, to exclude specific manufacturing systems from manufacturing certain parts, to exclude specific metrology hardware from measuring certain parts, to alert designated users that manufacturing system or metrology device uncertainty deviates from the calibration value provided by the machine manufacturer, or to provide an output comparison report of all inspectors for review by inspection management personnel.

At block 420, the analytics engine 150 can generate an uncertainty report representing feature-based uncertainty scores attributable to particular manufacturing systems, metrology devices, and/or inspectors or of combinations of manufacturing systems, metrology devices, and/or inspectors. These reports can include uncertainty scores attributable to the equipment and/or personnel of a single company or from a number of different suppliers in a supply chain relationship. These feature-based uncertainty scores can be sorted in some embodiments so that the report can be easily assessed by a user to identify the most precise manufacturing systems, metrology devices, and/or inspectors for particular geometric features. A number of feature-based uncertainty scores can be analyzed corresponding to the geometric features of a particular part in order to identify the most precise combination (or a number of capable combinations) of a particular manufacturing system, metrology device, and inspector for the creation of that part.

At block 425, the analytics engine 150 can identify the geometric features and associated tolerances of a part. At decision block 430, the analytics engine 150 can compare the tolerances of the geometric features to feature-based uncertainty scores in one or more uncertainty reports to provide one or more recommendations regarding manufacturing setups capable of manufacturing and inspecting the part. A manufacturing setup can include specific manufacturing system, metrology device, and inspector combinations to implement the manufacturing and inspection lifecycle of the part. If any uncertainty score in a report exceeds a threshold percentage of a tolerance, the process 400 can move to block 435 to provide an indication regarding one or more inspection operators and/or combinations to exclude from manufacture and/or inspection of the part. This can beneficially stop parts from being scrapped due to being manufactured and/or inspected by machines or personnel who are not capable of creating or measuring within the designated tolerances. If no uncertainty score in a report exceeds a threshold percentage of a tolerance, the process 400 can move to block 440 to provide a recommendation regarding one or more inspection operators and/or combinations to manufacture and/or inspect the part. Block 440 can involve filtering, from the recommendations set, any manufacturing setups where the manufacturing system or metrology device is not suitable for manufacturing or inspecting the material of the part (e.g., certain systems may not be rigid enough to manufacture Invar parts, or optical metrology systems may not be suitable for inspecting highly reflective materials such as Kapton). The indications and recommendations can be managed by the multi-tenant manager 130 in some embodiments. The percentage of tolerance can be 10%, 30%, 50%, 70%, or 100%, to name a few examples, and can be varied based on balancing the specific needs of a particular manufacturing-inspection cycle. In some preferred examples, the combined uncertainty score of the manufacturing system, metrology device, and human inspector involved in making a particular geometric feature is 10% or less of the smallest tolerance specified for that feature in engineering schematics (e.g., where a certain part has three cylinders each associated with a different tolerance, the uncertainty score should be 10% or less of the smallest tolerance).

For example, when a OEM company creates or uploads engineering schematics of a part, the analytics engine can implement block 425 to analyze its geometric features and associated tolerances. In some implementations, the user of the OEM who uploads the part may or may not also be the user designated to manage the OEM's supply chain, e.g. by selecting suppliers (or in-house equipment and personnel) to manufacture particular parts. When the engineering schematics are uploaded, the MLM system can send a notification to the user(s) designated by the OEM as managing supply chain and/or part creation, wherein the notification includes an indication that new engineering schematics were uploaded and a user-selectable option to identify any in-house manufacturing setups or suppliers capable of manufacturing and inspecting the part. Upon user selection of the feature, the analytics engine can determine capabilities of the in-house and supplier manufacturing setups relating to manufacturing and inspecting the geometric features of the part. In other examples, the MLM system may generate the described recommendations automatically upon detection of a new uploaded engineering schematic, or may automatically generate recommendations per user-specified rules, e.g. wanting to receive recommendations for all parts including cylinders.

To determine manufacturing setup capabilities, the analytics engine can access the user data repository 180 to identify known suppliers of the OEM (or a subset who have known capability for producing this type of part) and/or any in-house assets of the OEM. The analytics engine can implement blocks 405-420 to generate an uncertainty report representing the capability of inspectors, metrology devices, and/or manufacturing systems of the suppliers with respect to the identified features of the part. From there, the analytics engine can implement blocks 425, 430, and 440 to recommend one or more suppliers (and particular equipment and/or personnel at these suppliers) that can both manufacture and inspect the geometric features of the part within the designated tolerances.

As used herein, a manufacturing setup includes at least one manufacturing system, at least one metrology device, and at least one human inspector that will take raw materials through the stages of manufacturing and inspection. In some examples, a manufacturing setup includes a single manufacturing system, a single metrology device, and a single human inspector. In other examples, two or more manufacturing systems, metrology devices, or inspectors may be needed for different geometric features of a part. For example, some parts may require several different types of metrology devices to measure various geometric features—e.g., surface contours vs. thickness—and thus a manufacturing setup recommendation can include a complete set of the devices and associated inspectors that would be needed to manufacture and inspect the part. If the MLM system determines (e.g., based on predetermined inspection rules relating to particular metrology devices) that one metrology device can't measure everything on a part, the MLM system can look for the devices that would best suit individual features.

As another example, when a manufacturing company (e.g., a supplier) is tasked with creating a part the analytics engine can implement block 425 to analyze its geometric features and associated tolerances, can access the user data repository 180 to identify manufacturing systems, metrology devices, and inspectors of the manufacturing company, can implement blocks 405-420 to generate an uncertainty report for the identified inspectors, metrology devices, and manufacturing systems with respect to the identified features, and can implement blocks 425, 430, and 440 to recommend one or more combinations of manufacturing systems, metrology devices, and inspectors at the manufacturing company that can both manufacture and inspect the geometric features of the part within the designated tolerances.

Turning now to FIG. 5, an example process 500 for determining inspector capabilities by isolating the portion of measurement uncertainty attributable to the human inspector will be described in greater detail. The process 500 can be implemented by the analytics engine 150 in some embodiments. The feature-specific measurements in the data described with respect to FIG. 5 can be aggregated, in some embodiments, from inspection data standardized via process 200. In some embodiments, the process 500 may use inspections of a number of geometric features conducted within a particular tolerance range (e.g., 1/1000^{th} of an inch) to determine uncertainty within a particular tolerance range rather than for a particular geometric feature.

Process 500 can be used to identify human inspector capabilities per geometric features, and some embodiments can get more even granular, for example identifying capabilities per feature in combination with specific metrology device(s) and/or manufacturing system(s). Preferably, each inspection in the MLM system 110 can be tied to a human inspector (user), metrology device used to inspect the part, and manufacturing system used to make the part. For a given inspector, all inspections they have taken across all parts and assemblies are tied to that inspector in the MLM system databases.

At block 505, the analytics engine 150 can identify an aggregated data set associated with an inspector for a geometric feature. The aggregated data set can include a number of measurements taken by the inspector of the geometric feature. The geometric feature measurements can involve the same part, different parts in a run, and/or parts manufactured based on different models. Each measurement can be associated with a measured value, a nominal value for that part surface or portion, and one or more tolerance limits. Block 505 can be performed, in some embodiments, after the analytics engine 150 identifies that a threshold number of inspections of the feature have been obtained by the inspector. In one example the threshold can require the aggregated data set to include at least 50-100 inspections of the feature.

At block 510, the analytics engine 150 can perform accuracy calculations to determine a first portion of the uncertainty score of the inspector.

At block 510A, for each measurement in the aggregated data, the analytics engine 150 can calculate the deviation of the measurement from the nominal value and can then calculate the percentage of that deviation from the associated tolerance. In instances where there is both an upper tolerance limit and a lower tolerance limit, the deviation can be calculated as a percentage of the upper tolerance limit if the deviation is above nominal or can be calculated as a percentage of the lower tolerance limit if the deviation is below nominal.

At block 510B, the analytics engine 150 can calculate the mean of the percentages deviations of tolerance calculated at block 510A. Blocks 510A and 510B can be programmatically combined into a single function in some embodiments. As used herein, the calculation of a “mean” represents one way to determine an aggregate value for a particular variable. In alternate implementations, root mean squared or standard deviation can be used instead of mean.

At block 510C, the analytics engine 150 can calculate the mean tolerance based on the absolute values of the tolerances factored into the calculation of the mean percentage deviation of tolerance.

At block 510D, the analytics engine 150 can store the mean percentage deviation of tolerance and the mean tolerance in association with the inspector in user data repository 180.

To illustrate block 510, consider the following example. Inspector A measures cylinder 1 at 7/1000 of an inch deviation from nominal, and the associated tolerance for cylinder 1 is +/− 10/1000 inches (plus or minus ten thousandths of an inch). Inspector A also measures cylinder 2 at − 6/1000 of an inch deviation from nominal, and the associated tolerance for cylinder 2 is +/− 20/1000 inches. The mean percentage deviation of tolerance can be calculated as follows: 0.007/.01=70%; −0.006/−0.02=30%; (70%+30%)/2=50%. The mean tolerance can be calculated as (| 10/1000|+|− 20/1000|)/2= 15/1000 of an inch.

Thus, in this example, the mean percentage deviation of tolerance of inspector A for cylinders is 50% and the mean tolerance is 15/1000 of an inch. Inspector A's accuracy score can be stated as 50% of a 15/1000 inch tolerance, meaning that 50% of the time inspector A can be expected to measure within tolerance of a 15/1000 inch tolerance.

At block 515, the analytics engine 150 can calculate an uncertainty score for inspector A associated with each geometric feature in the aggregated data. The uncertainty score can be represented as an interval of measurements in which inspector A can be expected to measure.

At block 515A, the analytics engine 150 can calculate a mean upper deviation value and a mean lower deviation value for measurements taken of the feature.

In GD&T, features of size are specified with both upper and lower tolerance values relative to a nominal value. For such features, at block 515A the analytics engine 150 can calculate both (1) mean deviation above nominal based on the values and number of deviations above nominal and (2) mean deviation below nominal based on the values and number of deviations below nominal.

However, in some circumstances a data set associated with an inspector and a feature of size may include only measurements above nominal or measurements below nominal. Further, in GD&T, features of position or positional features are specified with only a single unsigned tolerance value. For example, the feature position can be a vector axis of the geometric feature, and the associated tolerance provides a cylindrical tolerance zone around the feature axis. As another example, the feature position can be a point within the geometric feature, and the associated tolerance provides a spherical tolerance zone around the feature point.

In both of these circumstances at block 515A the analytics engine 150 can first calculate the mean “upper” deviation based on the mean of the measurement deviations. Analytics engine 150 can then calculate the mean “lower” deviation based on the mean of the measurement deviations for measurements falling between nominal and the mean “upper” deviation. In the circumstance where a feature of size is only associated with measurement deviations below tolerance, the mean “upper” and “lower” deviations can be negative values.

At block 515B, the analytics engine 150 can set an initial uncertainty range between the calculated mean upper and lower deviation values.

At block 515C, the analytics engine 150 can calculate mean machine uncertainty scores. The mean machine uncertainty scores include both (1) a mean manufacturing uncertainty score generated based on the uncertainty score of the manufacturing system associated with each feature measurement, and (1) a mean metrology uncertainty score generated based on the uncertainty score of the metrology device associated with each feature measurement. It will be understood that the associated manufacturing system was used to manufacture the feature and the associated metrology device was used to measure the feature. In some circumstances different manufacturing systems can be used to manufacture different geometric features of the same part, for example by swapping out different cutters in a CNC. These uncertainty scores can be represented as an interval of probable part measurements associated with the machine's manufacture/inspection.

At block 515D, the analytics engine 150 can adjust the initial range by subtracting the mean manufacturing system interval and the mean metrology device interval from the initial range. Block 515D operates to remove “known” machine uncertainty from the estimated measurement uncertainty attributable to the inspector. This adjusted mean range—the span of the interval between the mean upper and mean lower deviations minus estimated machine uncertainties—where the inspector can be expected to measure that feature in the future. As an example, consider that the initial mean range for inspector A is 0.011 mm, the mean range for the manufacturing systems is 0.004 mm, and the mean range for the metrology devices is 0.002 mm. The portion of the interval that is likely attributable to inspector A is 0.005 mm.

In some embodiments, block 515D can optionally include adjusting the mean range (minus machine uncertainty) to account for environmental variables including CTE (coefficient of thermal expansion), machining/inspecting setup, and machining/inspecting temperatures. One embodiment of the process 500 can attribute 50% of the remaining uncertainty to environmental variables. Considering the above example, the portion of the interval attributed to inspector A would be reduced to 0.0025 mm. In some circumstances, data associated with the inspections in the MLM system 110 can indicate that machining and/or inspection of parts in the aggregated data sets were performed in temperature-controlled environments, for example at recommended shop temperatures of 68 degrees Fahrenheit, and the percentage attributed to environmental factors may be reduced. In other circumstances temperature variations during and/or between manufacture and inspection can be known and the percentage attributed to environmental factors may be increased accordingly.

At block 515E, the analytics engine 150 can store the adjusted range in association with the inspector feature in the user data repository 180 as the inspector's uncertainty score for the specific geometric.

Blocks 515A-515E can be repeated for each geometric feature. The calculations of block 515 do not account for whether the features are from the same part or different parts, as each feature measurement is treated as a separate piece of data. In some embodiments, the aggregated data set can be partitioned based on feature and further based on size of feature, associated manufacturing systems and/or associated measurement devices, and blocks 515A-515E can be repeated for each partitioned data set.

In some embodiments, the analytics engine 150 can calculate a mean of the uncertainty scores generated by block 515 for a number of different geometric features. This mean can represent a global uncertainty score for the inspector and can be used in the MLM system 110 as a metric of the inspector's capabilities, for example to recommend the inspector for certain projects or rank the inspector relative to other inspectors. Preferably, this global uncertainty score would be calculated across all geometric features, manufacturing systems, and metrology devices.

Such inspector-specific uncertainty calculations are not present in existing manufacturing-inspection analysis systems. In existing systems, decisions are made based only on inspecting device uncertainty and manufacturing machine uncertainty.

Optional block 520 can be performed to utilize the determined uncertainty scores of the inspector within a manufacturing-inspection environment. As described above, the uncertainty score can include at least three values: mean percentage deviation of tolerance, mean tolerance, and at least one uncertainty interval. As described herein, instead of mean other metrics may be used, for example root mean squared or standard deviation.

In some implementations, the feature-specific uncertainty measures for the human inspectors (and any updated uncertainty measures for machining systems or metrology devices) may be pre-computed in advance of determining to generate a capability recommendation for a particular part at block 520. Beneficially, this can enable the system to deliver the recommendation to the designated user while avoiding excessive latency that may result from performing the disclosed uncertainty-measure-isolation calculations in real time. For example, if an OEM has a hundred in-house manufacturing setups and thousands of suppliers, with each supplier having multiple manufacturing setups, attempting to calculate the feature-specific measurement uncertainties for each component of each manufacturing setup in real time (e.g., responsive to a manufacturing setup recommendation request) can result in severe delays in delivering the recommendation. In contrast, accessing pre-computed uncertainty measures enables a vast range of manufacturing setups to be evaluated in real time in comparison to the engineering specifications of a particular part to be manufactured and/or inspected. In some implementations however at least some uncertainty measures may be calculated during recommendation generation.

At block 520A, the analytics engine 150 can identify the tolerance range associated with a feature to be measured. This can be a range between upper and lower tolerance values for features of size or a range between nominal and tolerance for features of position.

At block 520B, the analytics engine 150 can multiply the tolerance range by the inspector percentage deviation of tolerance calculated at block 510B.

At block 520C, the analytics engine 150 can take the multiplied tolerance range and adjust the range by the inspector uncertainty range for the feature as calculated at block 515D. This can represent an expected range of measurements that the inspector could obtain when measuring the feature.

At block 520D, the analytics engine 150 can determine whether the expected range is within the specified tolerance. If so, the process 500 moves to block 520E and the inspector can be recommended for measuring the feature, as the inspector is capable of measuring the part in tolerance assuming that the part is, in fact, within tolerance. If not, the process 500 moves to block 520F and the inspector can be recommended to not measure the feature, as measurements obtained by the inspector are likely to be out of tolerance even if the actual part is within tolerance. Such recommendations can be output by the multi-tenant manager 130 to one or more designated users.

To illustrate the calculations of block 520, consider the following example. Suppose the tolerance associated with a cylinder is 0.010 mm, the inspector has a 70% deviation of tolerance percentage, and the uncertainty range of the inspector for cylinders is 0.002 mm. By multiplying 70% and the 0.010 mm tolerance, the inspector is expected to measure the cylinder at 0.007 mm. The inspector's uncertainty range, 0.002 mm, is divided by 2 to yield an uncertainty range of plus or minus 0.001 mm from the expected measurement. Thus, the expected range of measurements by this inspector for this cylinder is 0.006 mm−0.008 mm. The entirety of this range falls within the 0.010 mm tolerance specification, so this inspector would be recommended as capable of measuring this cylinder.

Consider another example showing an alternate embodiment of block 520 to identify an uncertainty associated with an existing measurement. Suppose inspector A measures a cylinder at 1.005 inches, nominal for the measurement is 1.000 inches, and tolerance is plus or minus 0.006 inches. The analytics engine 150 could attach the uncertainty score to the measured deviation, so that in this example the uncertainty for this measurement is 1.005 inches+/−0.00125 inches, and the measurement could reasonably be anywhere between 1.00375 inches and 1.00625 inches. This measurement cannot be determined with certainty to be in tolerance, because everything in the range of 1.006-1.00625 is above the upper tolerance limit.

Some embodiments of the process 500 can use inspector uncertainty scores to recommend training of one or more inspectors using specific hardware and/or measuring specific geometric features in order to help inspectors improve their measurement accuracy. For example, if inspectors A, B, and C measure the same part, inspector A is 30% deviation of tolerance, B is 50% deviation of tolerance, and C is 75% deviation of tolerance (on the same manufactured part or generally) then their relative uncertainty scores reveal who needs more training.

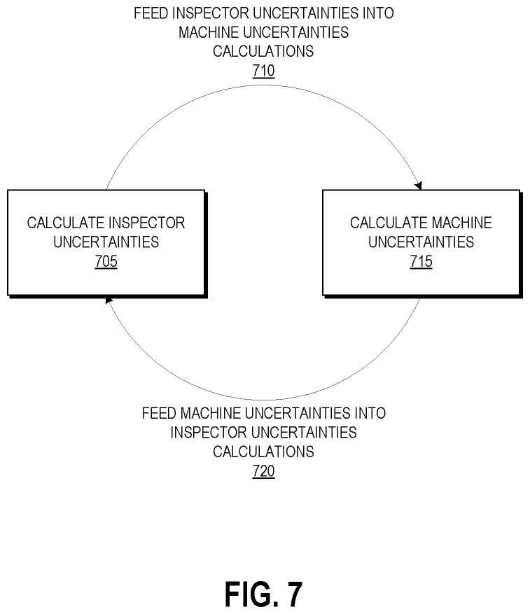

Another use of the inspector uncertainty scores includes the machine uncertainty refinement described with respect to FIG. 6. In one embodiment, inspector scores can first be calculated using equipment/device uncertainty data from manufacturer-provided calibration data to get preliminary inspector scores. Once the inspector scores stabilize in the system, the analytics engine can use the stabilized scores to identify whether equipment/device uncertainty corresponds to that provided by the manufacturer, and can use actual equipment/device uncertainty to refine inspector uncertainties. This feedback loop is discussed more with respect to FIG. 7.

It will be appreciated that blocks 505-515 of the process 500 can be updated based on newly acquired inspection data. In some embodiments, the process 500 can be repeated in real time as new inspection data is acquired. In some embodiments, the process 500 can be repeated at predetermined intervals, for example once per day or once per week. In some embodiments, the process 500 can be repeated once a threshold amount of new inspection data is acquired, for example after every 50 or 100 new inspections for a feature. In some embodiments, the process 500 can be executed in response to a user request that requires generating an uncertainty score.

FIG. 6 illustrates an example process 600 for generating uncertainty scores associated with a target machine a manufacturing-inspection environment, where the target machine can be a manufacturing system or a metrology device. The process 600 can be implemented by the analytics engine 150 in some embodiments. The feature-specific measurements in the data described with respect to FIG. 6 can be aggregated, in some embodiments, from inspection data standardized via process 200.

At block 605, the analytics engine 150 can identify inspection data associated with a target machine. For a manufacturing system, this can include inspection data sets of parts manufactured using the equipment. For a metrology device, this can include inspection data sets of parts inspected by the metrology device.

Analytics engine 150 can perform block 610 for each inspection in the inspection data set to determine whether or not to include the inspection in the aggregated data used in block 615. At decision block 610A, the analytics engine 150 can determine whether there is an uncertainty score associated with the inspector of the inspection data set. The uncertainty score for the inspector can be calculated as described with respect to the process 500 or by any other suitable calculations. In some embodiments, decision block 610A can include simply identifying whether there is an uncertainty score associated with the inspector for that feature in the user data repository 180. Inspectors may not have associated uncertainty scores in circumstances in which insufficient inspection data has been collected by the inspector for that feature.

In some embodiments, block 610A can include determining whether the inspector's uncertainty score has stabilized and including the inspection data in the aggregated data set only for stabilized scores. For example, analytics engine can determine that the uncertainty score varies less than a threshold percentage over a period of time or over a number of updated calculations. As another example, analytics engine can determine that the uncertainty score stops varying beyond a predetermined decimal point, for example five decimal points for measurements in inches or three decimal points for measurements in millimeters.

In some embodiments, process 600 can use and/or be limited to data from inspections performed by coordinate measurement machines (CMMs) operated without human inspectors, as such devices typically have known negligible uncertainty intervals of only a few microns. As such, some implementations of block 610A can identify whether the inspector of an inspection is a CMM, and if so may include the inspection in the aggregated data.

Though not illustrated, some embodiments may partition aggregated data into multiple sets to provide a number of uncertainty scores for the target machine. For example, the aggregated data can be partitioned into two or more sets based on temperature at which the parts were manufactured and/or inspected in order to provide temperature-specific uncertainty scores for the target machine. In other examples, the aggregated data can be partitioned into two or more sets based on part material, machine tooling (diamond cutters, carbide cutters, high speed steel cutters, and the like), machine programming, proximity to massive objects (such as mountains, as the gravitational field can pull a non-digital gauge in a metrology device towards it thus affecting the resultant measurements), and the like.

Once all inspections have passed through block 610, the analytics engine 150 can move to block 615. In some embodiments the measurements in the aggregated data can be associated with a specific geometric feature, and block 615 can be repeated using the measurements for each feature in the aggregated data. At block 615, the analytics engine 150 can calculate a deviation of each measurement from the associated nominal value and calculate a mean value of these deviations. Analytics engine 150 can further calculate a mean inspector uncertainty based on the uncertainty scores of the inspectors who contributed to the measurements of the geometric feature under consideration and the number of inspectors who contributed. Analytics engine can then subtract the mean inspector uncertainty from the mean deviation to calculate the uncertainty score of the target machine for that geometric feature. If process 600 is determining a manufacturing uncertainty interval of a manufacturing system, block 615 can also include calculating a mean of values representing default and/or calculated uncertainty for metrology devices associated with the aggregated data and subtracting this value together with the mean inspector uncertainty score. If process 600 is determining the measurement uncertainty interval of a metrology device, block 615 can also include calculating a mean of values representing default and/or calculated uncertainty for manufacturing systems associated with the aggregated data and subtracting this value together with the mean inspector uncertainty score.

After calculating the uncertainty score of the target machine for each geometric feature, the analytics engine 150 can move to block 620 to calculate the mean of the uncertainty scores.

At block 625, this mean of uncertainty scores is stored in association with the machine (manufacturing system or metrology device) in the asset portfolio of the user data repository 180.

Optionally, at block 630, the analytics engine 150 can cooperate with the multi-tenant manager to provide an alert to a designated user based on the mean uncertainty. For example, the alert can include an alert that the machine requires recalibration and/or that operation of the machine should be halted. Additionally or alternatively, the analytics engine 150 can output a command through the network 108 to the machine or to a computing device operating the machine, where the command halts operation of the machine. This can include ceasing manufacture using a manufacturing system or disabling a metrology device for use in further inspections. Such an alert or command can be based on the analytics engine 150 (1) comparing the mean of uncertainty scores to the default uncertainty score in the calibration data of the machine and (2) identifying that the mean of uncertainty scores is 30% or more greater than the default uncertainty score. Additionally or alternatively, such an alert or command can be based on the analytics engine 150 (1) performing outlier detection on a data set including number of uncertainty scores calculated for the machine and (2) determining that the mean of uncertainty scores is an outlier of the data set.

Another use of a machine uncertainty score obtained via the process 600 includes making determinations about manufacturing system capability to produce in-tolerance parts. For example, before manufacturing a part the analytics engine 150 can determine, for any feature of the part, whether the uncertainty range of any equipment in the asset portfolio associated with a user exceeds the specified feature tolerance range. If the tolerance range is exceeded by machine uncertainty, the MLM system 110 can alert a designated user to not use that equipment for manufacturing the part.

Another use of a machine uncertainty score obtained via the process 600 includes making determinations about metrology device capability to generate in-tolerance measurements of parts. For example, before inspecting a part the analytics engine 150 can determine, for any feature of the part, whether the uncertainty range of any metrology device in the asset portfolio associated with a user exceeds the specified feature tolerance range. If the tolerance range is exceeded by metrology device uncertainty and/or the uncertainty of a combination of metrology device and a specific inspector, the MLM system 110 can alert a designated user to not use that device and/or inspector for measuring the part.

The MLM system 110 can use the uncertainty scores output from the processes 500, 600 to provide recommendations for specific manufacturing system, metrology device, and inspector combinations for handling the manufacturing-inspection lifecycle of a part. In some embodiments, the MLM system can recommend combinations having combined uncertainty range that is at most 30% of tolerance for a part or of any feature of the part.

FIG. 7 depicts an example feedback loop for refining inspector and machine uncertainty scores. The feedback loop can be implemented by the analytics engine 150 in some embodiments, and may be pre-computed in advance of preparing particular manufacturing setup recommendations. Data described with respect to FIG. 7 can be aggregated, in some embodiments, from inspection data standardized via process 200.

At block 705, the analytics engine 150 can calculate inspector uncertainty scores representing an interval of likely actual measurement values for parts measured by each of a number of inspectors. The uncertainty score for each inspector can be calculated as described with respect to blocks 505-515 of process 500 in some embodiments. As described above, the uncertainty score associated with an inspector can be adjusted to remove machine uncertainty scores. The machine uncertainty scores represent the measurement uncertainty likely attributable to the manufacturing systems used to manufacture the measured parts and the metrology devices used to perform the inspection, which can initially be obtained from the machines' calibration data or can be updated based on obtained metrology data via process 600. Thus, the inspector uncertainty scores are generated based on current machine uncertainty scores.

The analytics engine can take the uncertainty scores calculated at block 705 and feed this data 710 into block 715. At block 715, the analytics engine 150 can calculate machine uncertainty scores representing an interval of likely actual measurement values for parts manufactured by each of a number of machines and/or measured by each of a number of metrology devices. The uncertainty score for each machine can be calculated as described with respect to blocks 605-625 of process 500 in some embodiments. As described above, machine uncertainty scores can be calculated based on mean deviation from nominal minus inspector uncertainty or a fraction of inspector uncertainty. Thus, the machine uncertainty scores are generated based on current inspector uncertainty scores.

The analytics engine can take the machine uncertainty scores calculated at block 715 and feed this data 720 back into block 705. As machine uncertainty scores are refined, the uncertainty scores of inspectors whose inspection data sets involve these machines are refined by re-calculating the inspector uncertainty based on the updated machine uncertainty scores.

The analytics engine can take the updated inspector uncertainty scores calculated at block 705 and feed this data 715 back into block 715. As inspector uncertainty scores are refined, the uncertainty scores of machines having inspection data sets involving these inspectors are refined by re-calculating the machine uncertainty based on the updated inspector uncertainty scores.

The feedback loop can be initiated by the MLM system periodically, for example once per day, or can be executed as new inspection data is obtained. The feedback loop can continue in some embodiments until convergence. Convergence can be defined as a cessation of change, within a threshold level, in uncertainty scores between successive iteration of blocks 705 and 715. The order of magnitude of the threshold level can be set based on metrology device resolution in some implementations, for example at the fifth decimal place of measurement values in inches or the third decimal place of measurement values in millimeters. In other embodiments the feedback loop can run for a number of iterations of blocks 705 and 715, for example 10 iterations, 50 iterations, 100 iterations, or more. The number of iterations can also be dynamically determined based on the amount of new inspection data relative to a previous run of the feedback loop, for example by performing one iteration for every 10, 50, or 100 new inspections.

In some embodiments, the feedback loop can be feature-specific, and multiple versions of the feedback loop can be performed sequentially or in parallel to refine feature-specific inspector and machine uncertainty scores. Some embodiments of the feedback loop may use global uncertainty scores for inspectors and machines, for example a mean uncertainty score across all features, and can adjust known feature-specific scores based on the finalized global scores output from the feedback loop.

### Implementing Systems and Terminology

Implementations disclosed herein provide systems, methods and apparatus for electronic manufacturing quality management analysis. One skilled in the art will recognize that these embodiments may be implemented in hardware, software, firmware, or any combination thereof.

As used herein, “mean” refers to an arithmetic mean computed by adding values and dividing by the number of values.

The foregoing embodiments have been presented by way of illustration, and not limitation. Thus, nothing in the foregoing description is intended to imply that any particular feature, characteristic or step is essential to the invention. For example, although portions of this disclosure refer to a web site that provides electronic manufacturing quality management analysis functionality, the invention is not limited either to web site based implementations or to electronic manufacturing quality management analysis systems. For example, some implementations may be hosted locally rather than through a networked web site.

The various components shown in FIG. 1, and the various processes described above may be implemented in a computing system via an appropriate combination of computerized machinery (hardware) and executable program code. For example, the multi-tenant manager 130, standardization engine 140, analytics engine 150, and model viewing engine 160 of the MLM system 110 may each be implemented by one or more physical computing devices (e.g., servers) programmed with specific executable service code. Each such computing device typically includes one or more processors capable of executing instructions, and a memory capable of storing instructions and data. The executable code may be stored on any appropriate type or types of non-transitory computer storage or storage devices, such as magnetic disk drives and solid-state memory arrays. Some of the services and functions may alternatively be implemented in application-specific circuitry (e.g., ASICs or FPGAs). The model viewing engine 160 can include one or more graphics processing units and associated memories with instructions for rendering interactive three-dimensional representations of objects.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Depending on the embodiment, certain acts, events, or functions of any of the algorithms, methods, or processes described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

The various databases and data repositories metrology data repository 170 and user data repository 180 may be implemented using relational databases, flat file systems, tables, and/or other types of storage systems that use non-transitory storage devices (disk drives, solid state memories, etc.) to store data. Each such data repository may include multiple distinct databases. In a typical implementation, the data provided to users, including the data presented by a user interface relating to metrology data analyses, are based on an automated analysis of many recorded events, for example part inspections. The user interface may, in some embodiments, be provided to a user device from application code that runs on a remote computing resource, implemented wholly in client-side application code that runs on users' computing devices, or a combination thereof.

The standardization engine 140, multi-tenant manager 130, analytics engine 150, and model viewing engine 160, portions thereof, and combinations thereof may be implemented by one or more servers 120. In other embodiments, any of the standardization engine 140, multi-tenant manager 130, analytics engine 150, and model viewing engine 160, may be implemented by one or more server machines distinct from the servers 120. In yet other embodiments, the standardization engine 140, multi-tenant manager 130, analytics engine 150, and model viewing engine 160 may be implemented by one or more virtual machines implemented in a hosted computing environment. The hosted computing environment may include one or more rapidly provisioned and/or released computing resources. The computing resources may include hardware computing, networking and/or storage devices configured with specifically configured computer-executable instructions. A hosted computing environment may also be referred to as a cloud computing environment.

Further, the processing of the various components of the illustrated systems can be distributed across multiple machines, networks, and other computing resources. In addition, two or more components of a system can be combined into fewer components. For example, the various systems illustrated as part of the MLM system 110 of FIG. 1 can be distributed across multiple computing systems, or combined into a single computing system. Further, various components of the illustrated systems can be implemented in one or more virtual machines, rather than in dedicated computer hardware systems. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a” and “an” are to be construed to mean “one or more” or “at least one” unless specified otherwise.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the described MLM systems. Thus, nothing in the foregoing description is intended to imply that any particular feature, characteristic, step, operation, module, or block is necessary or indispensable. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

1. A metrology system comprising:
a data repository storing (i) measurements obtained by inspecting physical parts, (ii) supply chain relationship data indicating associations between a manufacturer and its suppliers; and (iii) data relating to uncertainty of the measurements, wherein the data relating to the uncertainty of the measurements includes (i) inspector uncertainty scores of human inspectors of the suppliers who inspected the physical parts, (ii) manufacturing uncertainty scores of manufacturing systems of the suppliers that manufactured the physical parts and (iii) metrology uncertainty scores of particular metrology devices of the suppliers used by the human inspectors to inspect the physical parts;
a computer-readable memory storing executable instructions; and
a processor programmed by the executable instructions to:
detect that engineering schematics of a physical part to be manufactured have been uploaded by the manufacturer;
analyze the engineering schematics to ascertain geometric features of the physical part;
identify sets of the measurements obtained by particular suppliers of the manufacturer based upon the supply chain relationship data;
identify capabilities of the suppliers to manufacture and inspect the geometric features of the physical part based on the data relating to uncertainty of the measurements in the sets obtained by the particular suppliers; and
output a recommendation of one or more suppliers to be used to build the physical part based upon the identified capabilities.

2. (canceled)

3. The metrology system of claim 1, wherein the processor is programmed by the executable instructions to:
calculate an inspector uncertainty score for a particular human inspector by isolating, in a set of the measurements obtained by the human inspector, a portion of the uncertainty attributable to the human inspector; and
identify the capabilities based at least partly on the inspector uncertainty scores.

4. The metrology system of any claim 3, wherein the processor is programmed by the executable instructions to calculate a set of inspector uncertainty scores each representing a capability of the human inspector with respect to a different geometric feature represented by the set of the measurements.

5. (canceled)

6. The metrology system of claim 1, wherein the processor is programmed by the executable instructions to identify particular manufacturing systems, particular metrology devices, and particular human inspectors of the subset of the suppliers that have the determined capabilities for manufacturing and inspecting the geometric features of the physical part.

7. The metrology system of claim 6, wherein the recommendation identifies the particular manufacturing systems, particular metrology devices, and particular human inspectors.

8. The metrology system of claim 6, wherein the processor is programmed by the executable instructions to filter, from the subset of the suppliers, any suppliers where the particular manufacturing systems or particular metrology devices are not suitable for manufacturing or inspecting a material of the physical part.

9. (canceled)

10. The metrology system of claim 1, wherein the processor is programmed by the executable instructions to identify the subset of the suppliers that have the determined capabilities based on, for each geometric feature of the geometric features of the physical part:
determining a feature-specific measurement uncertainty score for a particular supplier; and
confirming that the feature-specific measurement uncertainty score is below a threshold percentage of a tolerance specified for the geometric feature.

11. (canceled)

12. (canceled)

13. The metrology system of claim 1, wherein the processor is programmed by the executable instructions to:
aggregate the measurements from inspections of physical parts manufactured based on at least two different engineering schematics; and
convert data representing the inspections into a feature-based report format based on clustering particular ones of the measurements by geometric feature.

14. The metrology system of claim 13, wherein:
the engineering schematics of the physical part to be manufactured are different from the at least two different engineering schematics, and
the processor is programmed by the executable instructions to:
identify that the engineering schematics of the physical part to be manufactured share at least one common geometric feature with the at least two different engineering schematics, and
based on identifying the at least one common geometric feature, determine to use the measurements from the inspections to identify the capabilities of the suppliers.

15. The metrology system of claim 1, wherein, to output the recommendation, the processor is programmed by the executable instructions to:
generate measurement uncertainty scores for the subset of the suppliers having determined capabilities for manufacturing and inspecting the physical part, and
rank the suppliers based on measurement the measurement uncertainty scores.

16. A method comprising, as implemented by one or more computing devices:
receiving a request from a user to evaluate manufacturing setup capabilities for a physical part to be manufactured based on engineering schematics;
analyzing the engineering schematics to ascertain geometric features of the physical part;
identifying a manufacturing setup to evaluate for capabilities to manufacture and inspect the physical part, wherein the manufacturing setup includes a manufacturing system, a metrology device, and a human inspector;
accessing uncertainty scores generated based on analyzing measurement data of other physical parts made by the manufacturing setup, the other physical parts sharing at least one of the geometric features, the uncertainty scores representing quantities of measurement uncertainty attributable to each of the manufacturing system, the metrology device, and the human inspector for specific geometric features;
determining that the manufacturing setup has the capabilities to manufacture and inspect the physical part based on comparing the uncertainty scores to corresponding tolerances of the geometric features; and
outputting a recommendation that the manufacturing setup be used to build the physical part based upon the identified capabilities.

17. (canceled)

18. The method of claim 16, further comprising, for each geometric feature of the geometric features:
identifying an uncertainty score of the uncertainty scores that is specific to the geometric feature;
identifying a smallest tolerance specified for the geometric feature in the engineering schematics; and
determining that the uncertainty score is less than a threshold percentage of the smallest tolerance.

19. The method of claim 16, further comprising:
identifying a plurality of manufacturing setups to evaluate with respect to the capabilities to manufacture and inspect the physical part;
identifying a subset of the plurality of manufacturing setups that have the capabilities to manufacture and inspect the physical part based on comparing uncertainty scores of particular manufacturing setups to the corresponding tolerances of the geometric features; and
including the subset of the plurality of manufacturing setups in the recommendation.

20. (canceled)

21. (canceled)

22. The method of claim 19, further comprising filtering, from the subset of the plurality of manufacturing setups, any manufacturing setups not suitable for manufacturing or inspecting a material of the physical part.

23. (canceled)

24. A non-transitory computer-readable medium storing instructions that, when executed, cause one or more computing devices to perform operations for evaluating inspection capabilities for a physical part to be inspected based on engineering schematics, the operations comprising:
identifying a human inspector to evaluate for capability to inspect the physical part;
accessing an uncertainty score representing a quantity of measurement uncertainty attributable to the human inspector;
determining that the inspector has the capability to inspect the physical part based on comparing the uncertainty score to a tolerance specified in the engineering schematics for the physical part; and
outputting a recommendation that the human inspector be used to inspect the physical part.

25. The non-transitory computer-readable medium of claim 24, the operations further comprising:
analyzing the engineering schematics to ascertain geometric features of the physical part;
accessing a plurality of uncertainty scores each representing a quantity of measurement uncertainty attributable to the human inspector for a particular geometric feature of the geometric features; and
determining that the inspector has the capability to inspect the physical part based on comparing each uncertainty score to the tolerance specified in the engineering schematics for the particular geometric feature.

26. The non-transitory computer-readable medium of claim 25, the operations further comprising generating the plurality of uncertainty scores based on analyzing measurement data of other physical parts that were inspected by the human inspector and share the geometric features of the physical part.

27. The non-transitory computer-readable medium of claim 25, the operations further comprising, for comparing each uncertainty score to the tolerance specified in the engineering schematics for the particular geometric feature, determining that the uncertainty score is less than a threshold percentage of the tolerance.

28. The non-transitory computer-readable medium of claim 27, the operations further comprising identifying the tolerance from a plurality of different tolerances specified for different instances of the geometric feature in the engineering schematics.

29. (canceled)

30. (canceled)

31. The non-transitory computer-readable medium of claim 24, the operations further comprising generating the recommendation based additionally on one or both of a metrology uncertainty score of at least one metrology device identified for use by the human inspector and a manufacturing uncertainty score of at least one manufacturing system identified to manufacture the part before inspection by the human inspector.

32. (canceled)
